(19) United States
(12) Patent Application Publication
(10) Pub. No.: US 2003/0058255 A1
(43) Pub. Date: Mar. 27, 2003

(54) Image management system

(76) Inventor: Yoichi Yamagishi, Tokyo (JP)

Correspondence Address: FITZPATRICK CELLA HARPER & SCINTO, 30 ROCKEFELLER PLAZA, NEW YORK, NY, 10112, US

(21) Appl. No.: 10/244,465

(22) Filed: Sep. 17, 2002

(30) Foreign Application Priority Data
Sep. 21, 2001 (JP) 289055/2001
Sep. 27, 2001 (JP) 297199/2001
Sep. 28, 2001 (JP) 302972/2001

(51) Int. Cl. G09G 5/00

(52) U.S. Cl. 345/619

(57) ABSTRACT

The invention provides an image management system of a configuration capable of transmitting image information from an image pickup apparatus to an image management apparatus connected to a network, managing the image information registered by the image pickup apparatus in the image management apparatus, and opening such information on the network. The invention also provides an image pickup apparatus adapted for use in the aforementioned image management system and capable of controlling the setting for transmission of image information from the image pickup apparatus and the setting for opening the image on the network, according to the operation mode of the image pickup apparatus, more specifically the state and form of each of the photographing and reproducing modes.

### BACKGROUND OF THE INVENTION

1. Field of the Invention

The present invention relates to an image management system for widely disseminating the image data taken by the users, and an image pickup apparatus for taking the image to be disseminated.

2. Related Background Art

There is recently known an image pickup apparatus such as an electronic camera, for recording, reproducing and communicating a still image or a moving image, utilizing a memory card including a solid-state memory device as the recording medium.

Also there is constructed an image browsing system for uploading an image, taken with an image pickup apparatus, in a WWW (world wide web) server connected to a wide area network such as internet by transmission for example from a personal computer (PC) and disseminating such image on such network.

Such image browsing system allows the client, by connecting its own PC to the www server through the internet, to browse the image uploaded in the www server or to download the image file for further utilization.

However, in case of using such image browsing system, it has been necessary, after taking an image with the image pickup apparatus, to connect a memory card storing the photographed image to a PC and to select and upload the image to be opened into the www server by an application functioning on the PC, but such operations are very cumbersome and complex for the general user. Also such image uploading operation is not possible to the user who does not own a PC.

On the other hand, there can also be conceived a system in which an image pickup apparatus provided with a communicating function directly transmits the image data to the www server. Since the compact image pickup apparatus designed for portable use is generally inferior to the PC in the ease of observation or in the operability, a method of setting a reservation for image transmission in advance and executing the uploading of the taken image data at such set timing is considered suitable for such system, in consideration of the convenience of use. However, though such method is convenient in not requiring the works for selecting and transmitting each image data, but, since the photographed image data are collectively transmitted without any working, the method is associated with drawbacks that the content of the image data cannot be confirmed in advance as to whether it is to be disseminated or that the image cannot be arbitrarily processed.

Also in case of uploading plural images as a set, for example in case of a panorama image, in the www server, the processing as a panorama image may be hindered in the individually uploading method. Also in case of taking a panorama image with the image pickup apparatus, the final management information indicating the number of the image data constituting the set and the relative relationship of such panorama images is not fixed until the completion of a series of the panorama image pick-up operation. Therefore, if the uploading operation is executed while the panorama image pickup operation is still continued, a part of the panorama images transmitted at first from the image pickup apparatus to the www server and the remainder of the panorama images transmitted later from the image pickup apparatus to the www server, as well as the management data for such panorama images, may become not manageable collectively in the www server.

Thus, in the equipment for image uploading into the www server, the user interface is equipped with the required configuration and functions, but such configuration and functions are complicated and fixed, and are often not designed to match the method of use or needs of the user. For example, in the image pickup apparatus, the user interface is different for a beginner user who is not used to the manipulation and for a skilled user who is well used to the manipulation, no image pickup apparatus has such product specifications capable of satisfactorily responding to the requirements of such different levels of the users. It is therefore required to provide a user interface capable of meeting the requirements of the respective user levels.

### SUMMARY OF THE INVENTION

An object of the present invention is to solve the above-described drawbacks.

Another object of the present invention is to provide an image management system and an image pickup apparatus, adapted for use in an image browsing system.

As a preferred embodiment for such objects, the present invention provides an image pickup apparatus comprising:

memory means for storing an input image;

transmission means for transmitting information relating to the aforementioned image stored in the memory means, to an external apparatus;

operation means for executing an operation for opening the aforementioned information, transmitted to the external apparatus, to another apparatus; and

control means for controlling at least either of a transmitting operation by the transmission means and an operation by the operation means according to the function mode of the image pickup apparatus.

Still other objects of the present invention, and the advantages thereof, will become fully apparent from the following detailed description of the embodiments.

### BRIEF DESCRIPTION OF THE DRAWINGS

FIG. 1 is a view showing the configuration of an image management system of the present invention;

FIG. 2 is a view showing the configuration of an image pickup apparatus 100 in an embodiment 1;

FIG. 3 is a view showing the configuration of an image gateway 400 constituting an image management apparatus;

FIG. 4 which is composed of FIGS. 4A and 4B are flow charts showing the functions of the image pickup apparatus 100 in the embodiment 1;

FIG. 5 which is composed of FIGS. 5A and 5B are flow charts showing a network open process;

FIG. 6 is a flow chart showing an image request response process;

FIG. 7 is a flow chart showing the functions of the image gateway 400;

FIG. 8 is a view showing the configuration of the image pickup apparatus 100 in an embodiment 2;

FIG. 9 is flow chart showing the functions of the image pickup apparatus 100 in the embodiment 2;

FIG. 10 which is composed of FIGS. 10A and 10B are flow charts showing the functions of the image pickup apparatus 100 in the embodiment 2;

FIG. 11 is a flow chart showing a quick review process;

FIGS. 12A and 12B are views showing examples of the display image;

FIG. 13 which is composed of FIGS. 13A and 13B are flow charts showing the functions of the image pickup apparatus 100 in the embodiment 2;

FIG. 14 which is composed of FIGS. 14A and 14B are flow charts showing a quick review process;

FIGS. 15A and 15B are views showing examples of the display image;

FIG. 16 is flow chart showing the functions of the image pickup apparatus 100 in an embodiment 3;

FIG. 17 which is composed of FIGS. 17A and 17B are flow charts showing the functions of the image pickup apparatus 100 in an embodiment 3;

FIG. 18 which is composed of FIGS. 18A and 18B are flow charts showing a panorama image pickup process;

FIG. 19 is flow chart showing a panorama image pickup process;

FIG. 20 is a view showing an example of panorama image pickup;

FIGS. 21A and 21B are views showing a panorama image pickup in the horizontal direction;

FIGS. 22A and 22B are views showing a panorama image pickup in the vertical direction;

FIGS. 23A and 23B are views showing a two-dimensional panorama image pickup;

FIGS. 24A and 24B are views showing a panorama image pickup in the horizontal direction;

FIGS. 25A and 25B are views showing a panorama image pickup in the vertical direction;

FIGS. 26A and 26B are views showing a two-dimensional panorama image pickup; and

FIG. 27 is a view showing the configuration of the image pickup apparatus 100 in an embodiment 3.

### DESCRIPTION OF THE PREFERRED EMBODIMENTS

The preferred embodiments of the present invention will now be described in detail hereinafter with reference to the accompanying drawings.

(First Embodiment)

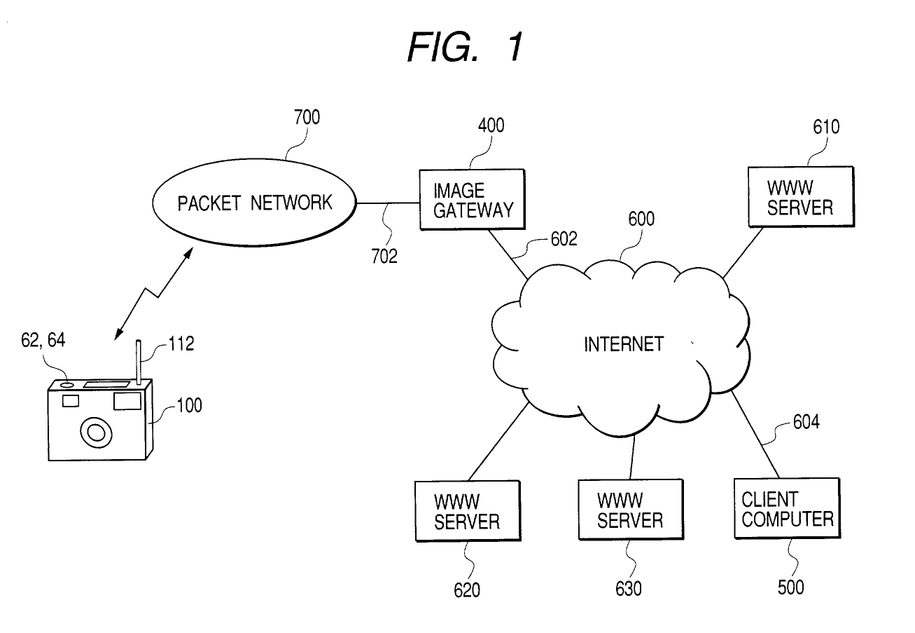

FIG. 1 is a view showing the configuration of entire system in an embodiment of the present invention.

An image pickup apparatus 100 such as an electronic camera is provided with communication unit and an antenna 112. An image management apparatus 400 is composed of an image management server for storing and managing image data and information relating to image, and is called an image gateway in the present embodiment. An information processing apparatus 500 is to be used by a general user and is called a client computer in the present embodiment. The client computer 500 can be composed of a personal computer, a portable information equipment or a mobile telephone.

There are also shown an internet 600, a network 602 for connecting the internet and the image gateway 400, a network 604 for connecting the internet and the client computer 500, and www servers 610, 620, 630 connected to the internet and adapted to store, open and distribute various contents information. The image gateway 400 may be of a configuration equivalent in function to the www server.

There are further shown a packet network 700 including a mobile telephone network such as a telephone station, and a network 702 for connecting the packet network 700 and the image gateway 400.

The image pickup apparatus 100 is so connected, through a telephone line, the packet network 700, network 702, image gateway 400, network 602 and internet 600, as to be capable of exchanging various contents including an image and various commands with the various network equipment including the www servers 610, 620, 630 and the client computer 500.

<Configuration of Image Pickup Apparatus 100>

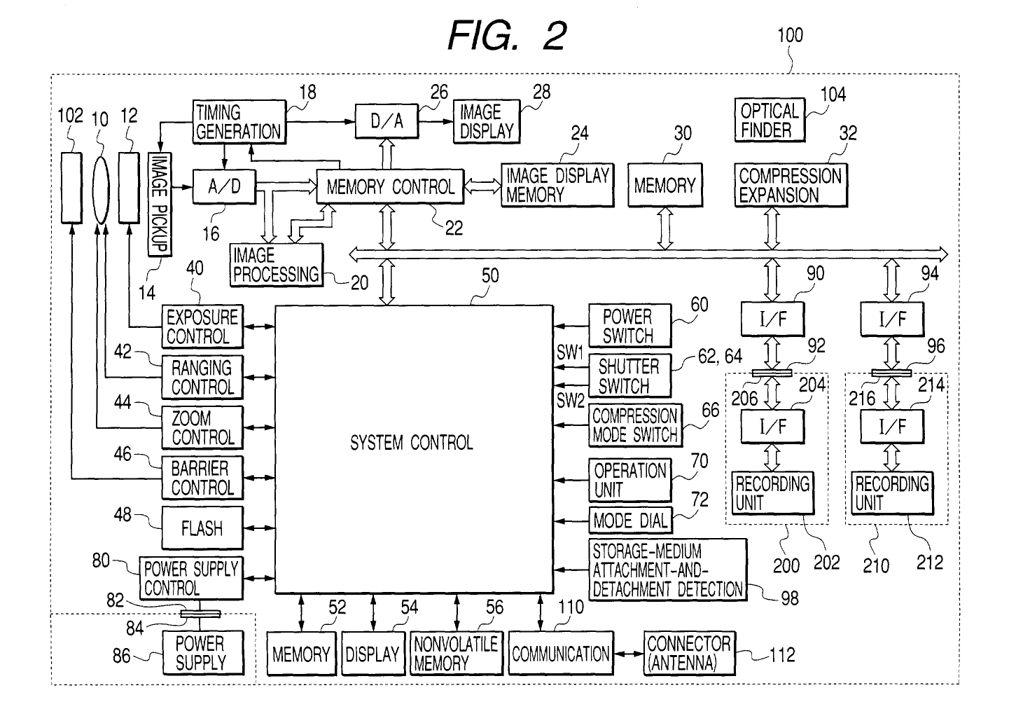

Now the image pickup apparatus 100 will be explained with reference to FIGS. 1 and 2.

There are provided an image pickup lens 10, a shutter 12 with a diaphragm function, an image pickup device 14 for converting an optical image into an electrical signal, an A/D converter 16 for converting the analog output signal of the image pickup device 14 into a digital signal, and a timing generation circuit 18 which supplies clock signals and control signals to the image pickup device 14, the A/D converter 16 and a D/A converter 26 and which is controlled by a memory control circuit 22 and a system control circuit 50.

An image processing circuit 20 executes a predetermined pixel interpolation process and a color conversion process on the data from the A/D converter 16 or those from the memory control circuit 22. It also executes a predetermined processing, utilizing the photographed image data, and the obtained result of processing is used by the system control circuit 50 in an AF (auto focus) process, an AE (auto exposure) process and an EF (flash pre-lighting) process of TTL (through-the-lens) method for controlling exposure control unit 40 and ranging control unit 42. The image processing circuit 20 also executes a predetermined processing, utilizing the photographed image data, for executing an AWB (auto white balancing) processing of TTL method based on the obtained result of processing.

A memory control circuit 22 controls the A/D converter 16, the timing generation circuit 18, the image processing circuit 20, an image display memory 24, the D/A converter 26, a memory 30 and a compression-expansion circuit 32. The data of the A/D converter 16 are written, either through the image processing circuit 20 and the memory control circuit 22 or through the memory control circuit 22, in the image display memory 24 or the memory 30.

There are further provided an image display memory 24, a D/A converter 26 and an image display unit 28 composed for example of a TFT LCD. The image data for display written in the image display memory 24 are displayed on the image display unit 28 through the D/A converter 26. An electronic viewfinder function can be realized by displaying the photographed image data in succession by the image display unit 28. The image display unit 28 can arbitrarily turn on/off the display by the instruction of the system control circuit 50, and the electric power consumption of the image pickup apparatus 100 can be significantly lowered in case the display is turned off.

A memory 30 for storing a photographed still or moving image has a memory capacity sufficient for storing a predetermined number of still images or plural cuts of moving images of a predetermined length. Thus the memory 30 can be used for executing a high-speed image writing operation of a large amount also in case of consecutive image pickup operations or a panorama image pickup operation in which plural still images are photographed in succession. The memory 30 can also be used as a work area for the system control circuit 50.

A compression-expansion circuit 32 for compressing or expanding the image data for example by adaptive discrete cosine transformation (ADCT) executes a compression or expansion process by fetching the image stored in the memory 30 and stores the processed data in the memory 30.

Exposure control unit 40 controls a shutter 12 provided with a diaphragm function, and also has a flash regulating function in combination with a flash 48. There are further provided ranging control unit 42 for controlling the focusing operation of the image pickup lens 10, zoom control unit 44 for controlling the zooming operation of the image pickup lens 10, barrier control unit 46 for controlling the function of protective unit 102 constituting a barrier, and a flash unit 48 which also has a function of projecting an AF auxiliary light and a flash regulating function.

The exposure control unit 40 and the ranging control unit 42 are controlled by the TTL method, and, based on the result of processing of the photographed image data by the image processing circuit, the system control circuit 50 controls the exposure control unit and the ranging control unit 42. There are provided a system control circuit 50 for controlling the entire image pickup apparatus 100, and a memory 52 for storing constants, variables and programs for the operations of the system control circuit 50.

A display unit 54 is composed for example of a liquid crystal display device, a speaker etc. for indicating an operation status, a message etc. by characters, images or voice according to the program execution in the system control circuit 50, and is provided in a single location or plural locations in the vicinity of an operation unit of the image pickup apparatus 100, in the form of a combination of LCD, LED, sound-generating device etc. Also a part of the function of the display unit 54 is provided in the optical viewfinder 104.

Among the contents displayed by the display unit 54, those displayed by the LCD etc. include the display for single shot/continuous shots, a self-timer operation, a compression rate, a number of recording pixels, a number of recorded frames, a number of remaining frames, a shutter speed, a diaphragm stop value, an exposure correction, a flash operation, a red-eye reduction state, a macro-photographing, a buzzer setting, a remaining capacity of clock battery, an error status, a numeral information of plural digits, an attached/detached status of recording media 200/210, an operation status of a communication I/F, time and date, a connection status with an external computer etc.

Also among the contents displayed by the display unit 54, those displayed in the optical finder 104 include the display for an in-focus state, a photographing stand-by state, a warning for hand vibration, a flash charging state, a flash charging completed state, a shutter speed, a diaphragm stop value, an exposure correction value, a writing operation into the recording medium etc. Also among the contents displayed by the display unit 54, those displayed by the LED etc. include the display for an in-focus state, a photographing stand-by state, a warning for hand vibration, a flash charging state, a flash charging completed state, a setting for macro-photographing, a charging state of secondary battery etc. Also a lamp etc. may be used for displaying the contents of the display unit 54, such as a self-timer informing lamp. Such self-timer informing lamp may also be used as the auxiliary light source for auto focusing.

An electrically recordable and erasable non-volatile memory 56 is composed for example of an EEPROM.

Operation unit 60, 62, 64, 66, 70, 72 for entering various instructions for operating the system control circuit 50 are composed of a switch, a dial, a touch panel, a pointing by sight line detection, a voice recognition device or a combination thereof.

These operation unit will be explained further in the following.

A power switch 60 can turn on or off the power supply to the various units of the image pickup apparatus 100.

A shutter switch SW1 62 is turned on by a half-way depression (first-step operation) of a shutter button constituting the shutter switch, thereby instructing the start of an AF (auto focusing) process, an AE (auto exposure) process, AWB (auto white balancing) process, an EF (flash pre-lighting) process etc.

A shutter switch SW2 64 is turned on by a complete depression (second-step operation) of the shutter button constituting the shutter switch, thereby instructing the start of an exposure process for writing the signal, read from the image pickup device 12 and processed through the A/D converter 16 and the memory control circuit 22, as image data into the memory 30, a development process by processing in the image processing circuit 20 and the memory control circuit 22, and a serial process for reading the image data from the memory 30, executing compression in the compression/expansion circuit 32, and recording the image data in the recording medium 200 or 210. As shown in FIG. 1, the switches SW1 (62) and SW2 (64) are composed of a single two-step switch.

A compression mode switch 66 is used for selecting either a compression rate of JPEG compression or a CCDPAW mode in which the signal from the image pickup device is directly digitized and recorded in the recording medium without compression.

In the JPEG compression mode, there are for example prepared a normal mode (high compression rate) and a fine mode (low compression rate). The image data are compressed in the compression/expansion circuit 32 according to the compression rate set by the compression mode switch 66, and are then recorded in the recording medium 200 or 210.

When the CCDRAW mode is selected, the image data are read from each line of the image pickup device 14 according to the pixel arrangement of the color filters thereof, then stored in the memory 30 through the A/D converter 16 and the memory control circuit 22, and such data are read from the memory and stored in the recording medium 200 or 210.

An operation unit 70, consisting of various buttons and a touch panel, includes a menu button, a set button, a macro button, a page-advance button in multi-frame image reproduction, a flash setting button, a single shot/continuous shot/self-timer switching button, a menu +(plus) shift button, a menu −(minus) shift button, a reproduced image +(plus) shift button, a reproduced image −(minus) shift button, a photographing image quality selecting button, an exposure correction button, a date/time setting button, an image display on/off button etc.

A mode dial switch 72 is used for selecting a photographing mode, a reproduction mode, a network connection mode or a standby mode. Also within the photographing mode, there can be selected sub modes such as an auto photographing mode, a manual photographing mode or a panorama photographing mode, and, within the reproduction mode, there can be selected sub modes such as a multi-frame reproduction mode or an erasing mode.

Power supply control unit 80 is composed of a battery detection circuit, a DC-DC converter, a switch circuit for switching the blocks to be energized etc., executes detection whether the battery is mounted, the type of battery and the remaining battery capacity, and controls the DC-DC converter based on the result of such detection and the instruction from the system control circuit 50, thereby supplying various units including the recording media with necessary voltages for a necessary period.

There are also provided connectors 82, 84, and power supply unit 86 consisting of a primary battery such as an alkali battery or a lithium battery, a secondary battery such as a NiCd battery, a NiMH battery or a Li-ion battery, or an AC adaptor.

There are further provided interfaces 90, 94 with a recording medium such as a memory card or a hard disk, connectors 92, 96 for connection with the recording medium such as a memory card or a hard disk, and recording medium attachment/detachment detection unit 98 for detecting whether the recording medium 200 or 210 is mounted on the connector 92 or 96.

In the present embodiment, it is assumed that the interface and the connector for the recording medium are provided in two systems. Naturally such interface and connector for the recording medium may be provided in a single system or in any number. Also the interfaces and the connectors of different standards may be provided in combination. Also the interface and the connector may be based on the standard for PCMCIA card or CF (compact flush) card.

In case the interfaces 90, 94 and the connectors 92, 96 are based on the standard for PCMCIA card or CF (compact flush) card, the image data and the management information associated therewith may be mutually transferred with peripheral equipment such as other computers or printers, by connecting various communication cards such as a LAN card, a modem card, a USB card, an IEEE1394 card, a P1284 card, a SCSI card or a PHS.

Protection unit 102 constitutes a barrier for covering the image pickup unit, including the lens 10 of the image pickup apparatus 100.

An optical viewfinder 104 enables the image pickup operation without relying on the electronic finder function by the image display unit 28. Inside the optical finder 104, there is provided a part of the functions of the display unit 54, for example displays for an in-focus state, a warning for hand vibration, a flash charging state, a shutter speed, a diaphragm stop value, an exposure correction value etc.

Communication unit 110 has a communicating function of a mobile telephone for example of PDC method, CDMA method, W-CDMA method or PHS method. The communication unit 110 may also be so constructed as to achieve communicating functions based on RS232C, USB, IEEE1394, P1284, SCSI, modem, LAN or wireless communication for example by Bluetooth. A symbol 112 indicates a connector for connecting the image pickup apparatus 100 with another equipment by the communication unit 110, or an antenna in case of wireless communication.

A memory medium 200 is composed of a memory card or a hard disk, and is provided with a recording unit 202 composed of a semiconductor memory or a magnetic disk, an interface 204 with the image pickup apparatus 100, and a connector 206 for connection with the image pickup apparatus 100.

A memory medium 210 is composed of a memory card or a hard disk, and is provided with a recording unit 212 composed of a semiconductor memory or a magnetic disk, an interface 214 with the image pickup apparatus 100, and a connector 216 for connection with the image pickup apparatus 100.

<Configuration of Image Gateway (Image Management Apparatus) 400>

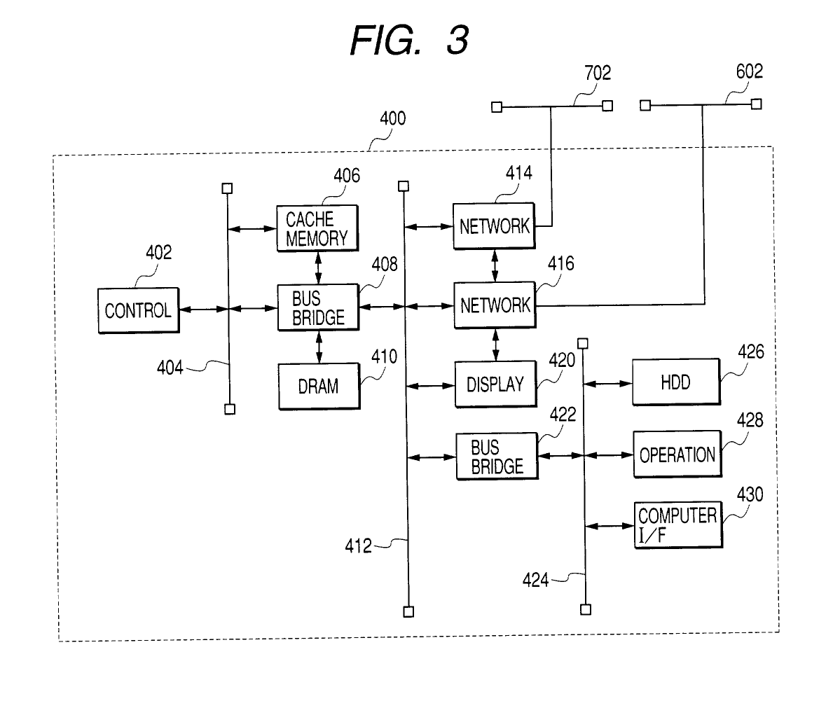

Now reference is made to FIG. 3 for explaining the aforementioned image gateway 400, which is realized for example by a server computer.

There are provided control unit 402 composed for example of a central CPU for controlling the entire image gateway, and a CPU bus 404 for connecting the control unit 402, a cache memory 406 and a bus bridge 408 thereby enabling high-speed transfer of the data processed by the control unit 402.

A cache memory 406, to be used in the function of the control unit 402 and enabling high-speed access from the control unit 420, is used for temporarily storing the data to be used in the processing of the control unit 402, and is generally composed of a high-speed SRAM etc.

A bus bridge 408 is used for connecting the CPU bus 404 and a high-speed bus 412 to be explained later, for absorbing the difference in the process speed between the buses. The presence of this bus bridge 408 allows the control unit 402, operating at a higher speed, to exchange data with the units connected to the high-speed bus 412. The bus bridge 408 is also provided with a memory controller function and executes certain memory management functions of reading the data, temporarily written in the cache memory 406 at a high speed by the control unit 402, at a predetermined timing and writing such data in a DRAM 410, or writing data, read from the DRAM 410 in response to a request from the control unit 402, into the cache memory 406.

A DRAM 410 constitutes a main memory to be used by the control unit 402 in executing various applications, and is generally composed for example of an SDRAM.

A high-speed bus 412, connecting the bus bridge 408, network unit 414, communication unit 416, display unit 420 and bus bridge 422, is used for transferring the data processed by the control unit 402 to various units or for high-speed data transfer (DMA transfer) among the units. In general it can be composed for example of a PCI bus.

Network unit 414, connecting the image gateway 400 with a network 702, is used for data exchange with an external network. The network to be connected can be, for example, an Ethernet. The image gateway 400 can be connected, through the network unit 414 and the network 702, to a packet network 700 including a mobile telephone network such as a telephone base station.

Network unit 416, connecting the image gateway 400 with a network 602, is used for data exchange with an external network. The network to be connected can be, for example, an Ethernet. The image gateway 400 can be connected, through the network unit 416 and the network 602, to the internet 600.

Display unit 420, composed of a liquid crystal display device, a speaker etc., executes display of necessary characters, images, voice etc. according to the program execution by the control unit 402.

A bus bridge 422, for connecting the high-speed bus 412 and a low-speed bus 424 to be explained later, is provided for absorbing the difference in the process speeds of the buses. The presence of the bus bridge 424 enables to each high-speed operating unit to execute data exchange with a low-speed operating unit connected to the low-speed bus 424.

A low-speed bus 424, which connects the bus bridge 422, a hard disk 426, operation unit 428 and a computer interface 430, has a transfer rate lower than that of the aforementioned high-speed bus 412, and is used for connecting units of a relatively slow processing ability. In general it is composed for example of an ISA bus.

A hard disk drive 426 includes a hard disk for storing plural applications and various information required in the operation of the control unit 402, and is under the management of the aforementioned control unit 402. The above-mentioned hard disk also stores the information on the information memory of the image pickup apparatus 100 and on the information stored therein.

Operation unit 428, composed of a keyboard, a microphone etc., is used for entering various settings required for the operation of the image gateway 400 and various instructions for the control unit 402.

A low-speed computer interface 430 connects the image gateway 400 and peripheral devices, and is generally composed of a RS632C for serial communication, a centronix interface for parallel communication, or P1284.

<Function of Image Pickup Apparatus 100>

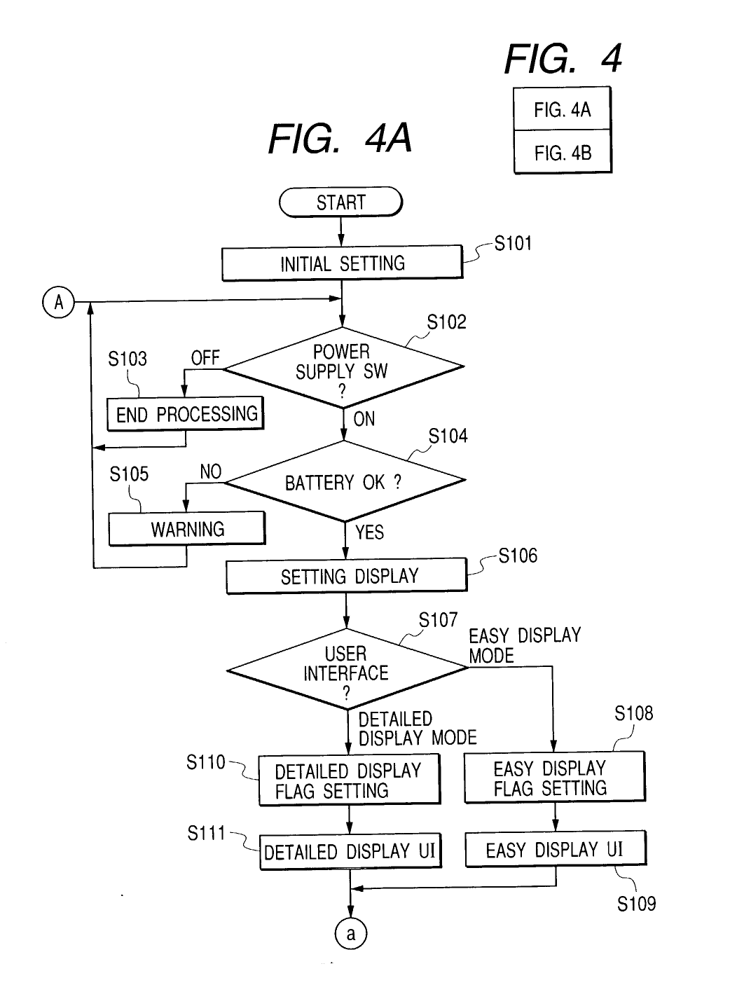

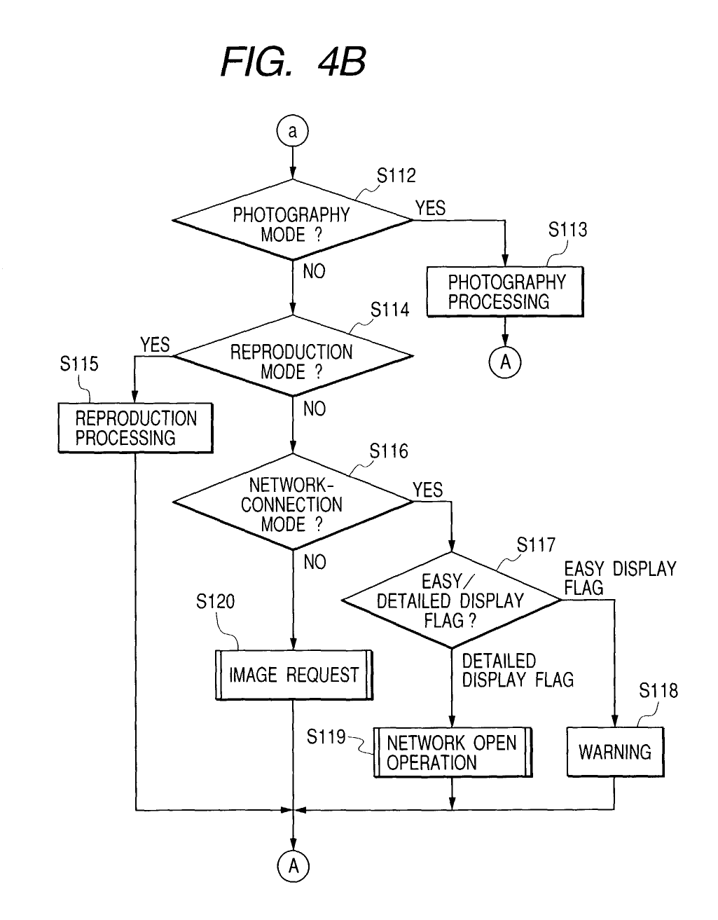

In the following there will be explained the function of the image pickup apparatus 100 of the present invention, with reference to FIGS. 4A and 4B, which are flow charts of a main routine of the image pickup apparatus 100.

In response to the start of power supply, for example by a battery exchange, the system control circuit 50 executes initialization of flags and control variables, and of various units of the image pickup apparatus 100 (S101). The system control circuit 50 judges the set position of the power supply switch 60, and, if set at a power supply off state (S102), executes a predetermined end process such as changing the display of the display units to an end state, recording the parameters, set values and set mode including the flags and control variables in the non-volatile memory 56, and causing the power supply control unit 80 to turn off the unnecessary power supply to various units of the image pickup apparatus 100 including the image display unit 28 (S103), whereupon the sequence returns to S102.

If the power supply switch 60 is set at a power supply on state (S102), the sequence proceeds to a step S104. The system control circuit 50 causes the power supply control unit 80 to judge whether the remaining capacity and the operation status of the power supply 86, composed of a battery or the like, have problems in the function of the image pickup apparatus 100 (S104), and, if there is any problem, it causes the display unit 54 to provide a predetermined warning display by an image or voice (S105), whereupon the sequence returns to S102. If there is no problem in the power supply 86 (S104), the sequence proceeds to a step S106.

The system control circuit 50 executes display of various set states of the image pickup apparatus 100, utilizing an image or voice by the display unit 54. If the image display of the image display unit 28 is turned on, such image display unit 28 is also used for displaying the various set states of the image pickup apparatus 100 by an image or voice (S106).

Subsequently, the system control circuit 50 determines the setting of the user interface involving a change in the display format, either in a detailed format or a simple format, according to the discretion of the user (S107). The user interface can be set within a range related to each operation mode, and either one of the detailed/simple format may be set as a default format.

Then, if S107 selects a simple user interface display for the user interface including the graphical user interface (GUI), a flag for simple display is set (S108) and the graphical user interface of the display unit 54 or the image display unit 28 is switched to the simple user interface display (S109). In such case, the highly advanced operations are basically not accepted, and the display is not given exceeding the necessary level. The GUI for simple display is a graphical user interface allowing minimum necessary display, setting and operations and excluding highly advanced settings, for facilitating access by the beginner users.

On the other hand, if S107 selects the detailed user interface display, a flag for detailed display is set (S110) and the graphical user interface of the display unit 54 or the image display unit 28 is switched to the detailed user interface display (S111). In such case, all the operations are accepted as far as possible, and the display is given in hierarchical manner following the operation sequence. The GUI for detailed display is a graphical user interface enabling detailed selection of the functions according to the situation, providing a detailed display or enabling operations in hierarchical manner, thereby allowing the skilled users to utilize the image pickup apparatus in more advanced manner.

The states of the simple display flag and the detailed display flag are stored in an internal memory of the system control circuit 50 or in the memory 52.

Subsequently, the system control circuit 50 judges the set position of a mode dial 72, and, if in a photographing mode (S112), executes a photographing and recording process (S113), and, upon its completion, the sequence returns to S102.

If the mode dial 72 is set at a reproduction mode (S114), the system control circuit 50 executes a predetermined reproduction process (S115), and, upon its completion, the sequence returns to S102.

If the mode dial 72 is not set at the photographing mode nor at the reproduction mode (S112, S114), the sequence proceeds to a step S116. If a network connection mode (S116), there is discriminated the set state of the simple/detailed display flag stored in the internal memory of the system control circuit 50 or in the memory 52 (S117), and, if the simple display flag is set, a predetermined warning display (for example “An open image cannot be registered at present”) is given by an image or voice by the display unit 54 (S118) whereupon the sequence returns to S102.

In this manner, when the simple display flag is set, there is not accepted an operation for a net open process for registering image information, recorded by the image pickup apparatus 100, in the image gateway 400 or opening or closing the already registered image. Also there is not displayed an explanation for the operations relating to the net open process.

The image registration in the present invention unit an operation of uploading image data from the image pickup apparatus 100 to the image gateway 400, or an operation of transmitting information relating to the image, for example sub information such as a thumbnail image or a file name.

Also opening/closing of the registered image unit whether to open or close the information, held by the image pickup apparatus 100 and registered in the image gateway 400, on the internet 600, and is called a net open process. The information on the image to be opened (open image) can be browsed in another apparatus such as the client computer 500, through the internet 600.

On the other hand, if the detailed display flag is set (S117), there is executed a setting process for determining the open/close state of the image (net open process) (S119), whereupon the sequence returns to S102. When the detailed display flag is set, the operations are executed by the detailed display user interface.

As explained in the foregoing, there can be automatically set whether or not to register the photographed image in the image gateway 400 and whether or not to open the photographed image on the internet through the image gateway 400 according to whether the graphical user interface (GUI) of the display unit 54 and/or the image display unit 28 is set at the simple user interface for the beginner users or at the detailed user interface for the skilled users, so that there can be avoided a drawback that the beginner user erroneously opens the image.

In the net open process routine S119, management information (also called open image list) for managing the image information registered by the image pickup apparatus 100 is held in the recording unit of the image gateway 400, and the image pickup apparatus 100 can change the setting for the images registered thereby, on the aforementioned open image list.

More specifically, the aforementioned open image list is contained in the HDD 426 of the image gateway 400, and constitutes information for registering information on the image registered by the image pickup apparatus 100 together with the location of the image pickup apparatus 100 (to be specified for example by an IP address) and for managing whether or not to open such image on the internet in the unit of an image, such information including an index consisting of a reduced image, a thumbnail, a file name etc. of such image.

Also in response to a remote control from the image pickup apparatus 100, it is possible to change the setting of such open image list and to set the open/close state of the registered image at any time. Also there can be executed a setting of opening all the registered images from the image pickup apparatus 100, a setting of closing all the registered images, and an addition/deletion of the open image. The details of such net open setting process S119 will be explained later.

Referring to FIGS. 4A and 4B, if the S116 identifies that the network connection mode is not set, an image request response process can be executed in a standby state (S120), and, upon its completion, the sequence returns to S102.

The image request response process routine (S120) is a process in which, in response to an image transmission request from the client computer 500, the image pickup apparatus 100 transmits the requested image (a copy of the original image data) to the client computer 500.

More specifically, the client computer 500 is capable of browsing the open information of various devices, including the image pickup apparatus 100, stored in the image gateway 400 and made open on the internet, and of specifying the location of the image or the file name thereof by referring to the aforementioned management information and emitting a request for the transmission of desired data. The details of the image request response process S120, executed by the image pickup apparatus 100 in response to such image request, will be explained later.

In the foregoing, there has been explained the process of the flow chart shown in FIGS. 4A and 4B.

In the following there will be given a detailed explanation on the format of the user interface. In the explanation of FIGS. 4A and 4B, it is explained that the format of the user interface can be selected according to the instruction by the user, but the present invention is not limited to such case and the user interface can be set under various conditions. At first, in the photographing mode, it is possible to set a simple user interface (simple display mode) in case the image pickup apparatus is in a photographing mode under automatic appropriate conditions such as an auto photographic mode, and to set a detailed user interface (detailed display mode) in case of a mode requiring the knowledge and skill of the user such as a diaphragm priority mode or a shutter speed priority mode.

It is also possible to set the user interface by entering the identification information (name, ID, age, sex etc.) of the user and selecting a mode suitable for the user, based on such identification information.

In the following there will be explained the net open process routine.

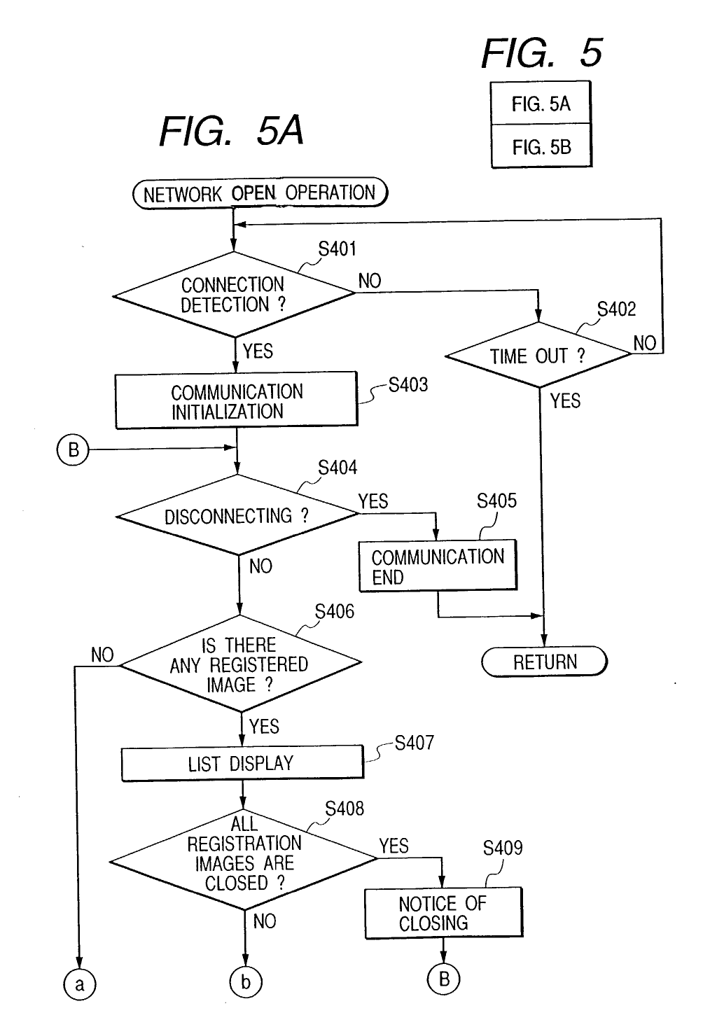

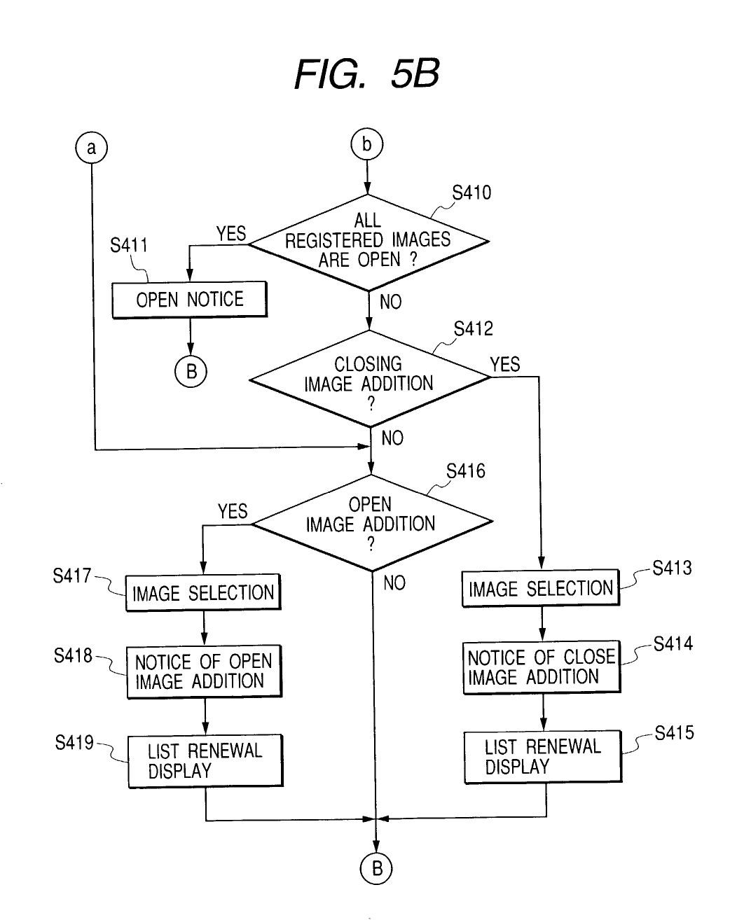

FIGS. 5A and 5B are flow charts showing the net open setting process routine in the step S119 in FIGS. 4A and 4B. The system control circuit 50 continues, for a predetermined time, detection of connection to the packet network 700 including the mobile telephone station through the communication unit 110 constituting a wireless communication I/F for the mobile telephone, by unrepresented detecting function of the communication unit 110 (S401, S402). If the connection state with the packet network 700 cannot be detected within the aforementioned predetermined time, a time-out state is reached (S402) and the net open setting process routine S119 is terminated.

In case the connection with the packet network 700 is detected (S401), the system control circuit 50 executes initialization of the communication function including the communication unit 110 (S403).

Subsequently, there is discriminated whether the connection state between the communication unit 110 and the packet network 700 is disconnected (S404), and, if not disconnected (S404), the sequence proceeds to a step S406, but, if disconnected (S404), the system control circuit 50 executes a predetermined communication ending process on the communication function, including the communication unit 110 constituting the wireless communication I/F for the mobile telephone (S405), and terminates the net open setting process routine S119.

Then the system control circuit 50 discriminates whether an image registered in the image gateway 400 is included in the image stored in the recording medium 200 or 210 (S406), and, if not included (S406), the sequence proceeds to a step S416.

The presence or absence of such registered image can be identified from the management information stored in a predetermined area in the image pickup apparatus 100 and/or the management information stored in the recording medium 200 or 210 and/or the open image list stored in the image gateway 400.

If the step S406 identifies the presence of a registered image, the system control circuit 50 displays a list of the registered images on the image display unit 28 and/or the display unit 54 (S407), and then proceeds to a step S408.

If an input by a switch and/or a dial of the operation unit 70 executes a close setting operation for closing all the open images on the internet 600 (S408), a setting for closing all the registered images is informed to the image gateway 400 (S409), and the sequence returns to the step S404. If the close setting operation for closing all the open images is not executed (S408), the sequence proceeds to S410.

If an input by a switch and/or a dial of the operation unit 70 executes an open setting operation for opening all the registered images (S410), a setting for opening all the registered images is informed to the image gateway 400 (S411), and the sequence returns to the step S404. If the open setting operation for opening all the registered images is not executed (S410), the sequence proceeds to S412.

If an input by a switch and/or a dial of the operation unit 70 executes an operation for canceling opening of a part of the open images and adding such part to the closed images (S412), images to be canceled from opening are selected by a switch and/or a dial of the operation unit 70 (S413), then the addition of the corresponding registered images to the closed images is informed to the image gateway 400 (S414), and the renewed open image list is displayed on the image display unit 28 and/or the display unit 54 (S415), whereupon the sequence returns to the step S404. If the operation for the addition of images canceled from opening is not executed (S412), the sequence proceeds to S416.

If an input by a switch and/or a dial of the operation unit 70 executes an operation for adding unopened registered images to the open images (S416), images to be additionally opened are selected by a switch and/or a dial of the operation unit 70 (S417), then the addition of the corresponding registered images to the open images is informed to the image gateway 400 (S418), and the renewed open image list is displayed on the image display unit 28 and/or the display unit 54 (S419), whereupon the sequence returns to the step S404. If the operation for the addition of the open images is not executed (S416), the sequence returns to S404.

Also in case of registering a newly photographed image or an unregistered image in the image gateway 400, single or plural photographed images are reproduced in succession from the recording medium 200 or 210 by an input with a switch and/or a dial of the operation unit 70 at an arbitrary timing in the network connection mode, thereby selecting the image to be registered, and sub information such as an index consisting of a thumbnail image, a file name etc. corresponding to the selected image is informed to the image gateway 400 and added to the registered images.

There may also be provided a mode of informing the image gateway 400 of a new registration in linkage with an image photographing operation. In such mode, the shutter switch performs a function similar to the image selection, and, for each photographing operation, informs the image gateway 400 of the sub information consisting of an index such as a thumbnail image and a file name of the photographed image, thereby achieving new registration.

The net open process after the new registration is similar to the open setting process, close setting process etc. explained in the foregoing.

As explained in the foregoing, the net open setting process routine S119 enables, by the manipulation on the user interface of the image pickup apparatus 100, to change the setting of the management information on the image registered from the image pickup apparatus 100 in the image gateway 400, thereby setting open/close state of the registered image at any time.

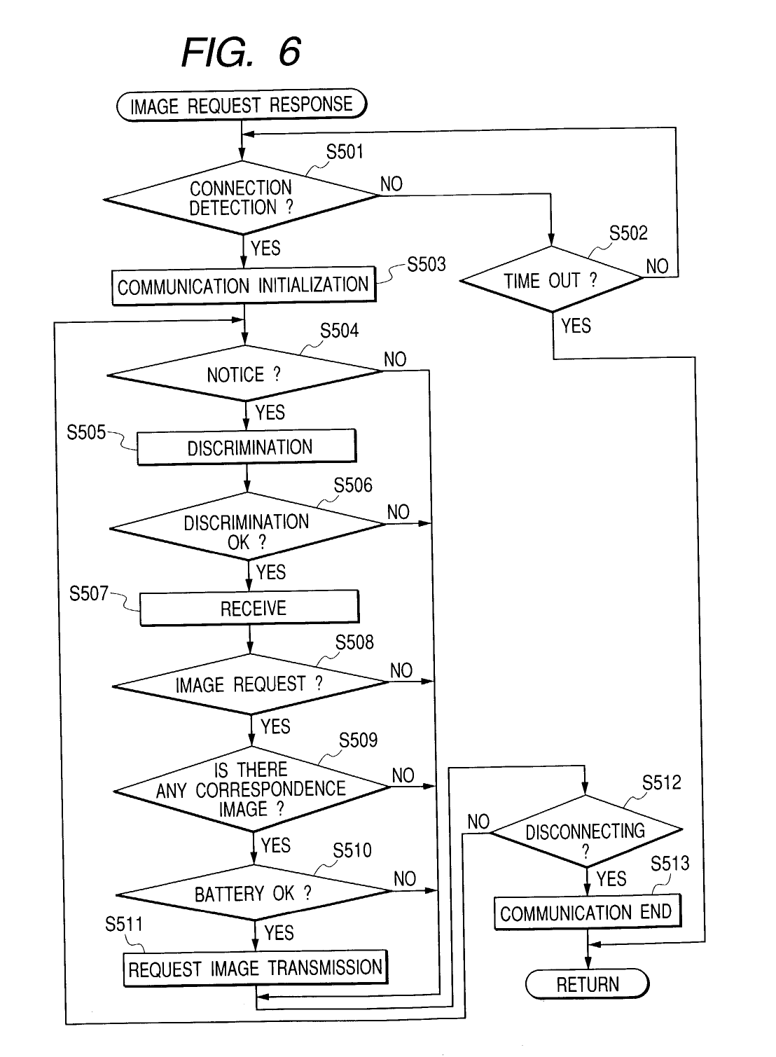

FIG. 6 shows a detailed flow chart of the image request response process in the step S120 in FIGS. 4A and 4B.

The system control circuit 50 continues, for a predetermined time, detection of connection to the packet network 700 including the mobile telephone station through the communication unit 110 constituting a wireless communication I/F for the mobile telephone, by the detecting function of the communication unit 110 (S501, S502). If the connection state with the packet network 700 cannot be detected within the aforementioned predetermined time, a time-out state is reached (S502) and the image request responding routine S120 is terminated.

In case the connection with the packet network 700 is detected (S501), there is executed initialization of the communication function including the communication unit 110 (S503).

Subsequently, the system control circuit 50 discriminates whether a command etc. has been informed from single or plural client computers 500 etc. connected to the internet (S504).

If not informed (S504), the sequence proceeds to a step S512. If a command etc. has been informed (S504), the system control circuit 50 executes identification and verification of the client computer 500 etc. which has sent the command etc. (S505), and, if the informed command etc. has a problem for reception (S506), the sequence proceeds to a step S512. If the identification process identifies that the informed command etc. has no problem for reception (S506), the sequence proceeds to a step S507.

The identification and verification of the client computer 500 etc. which has transmitted the command etc. can be achieved from the identification management information stored in a predetermined area in the image pickup apparatus 100 and/or the identification management information stored in the recording medium 200 or 210 and/or the management information stored in the image gateway 400.

Then the system control circuit 50 receives the command etc. informed from the client computer 500 etc. (S507), and, if the content of the received command etc. is identified as a command requesting transfer of single or plural image data (S508), discriminates whether an image corresponding to the request is stored in the recording medium 200 in the image pickup apparatus 100 and/or the recording medium 210 (S509). If the step S508 identifies that the received command etc. is not a command requesting image data, the sequence proceeds to a step S512.

In case of transmission of a proper request command as in the step S508, the client computer 500 etc. determines the image and the apparatus requested for transmission, by browsing, through the image gateway 400, the open images determined by the net open process of the step S119 and referring to the open image list obtained from the image gateway 400.

If the image corresponding to the request of the request command is not stored (S509), the sequence proceeds to a step S512. If the image corresponding to the request is stored (S509), the sequence proceeds to a step S510.

Then the system control circuit 50 causes the power supply control unit 80 to discriminate whether the remaining capacity and the operation status of the power supply 86, composed of the battery etc., have any problem for the image transmitting operation of the image pickup apparatus 100 (S510), and, if any problem, the sequence proceeds to a step S512. If there is no problem in the image transmitting operation of the image pickup apparatus 100 (S510), the single or plural requested image data are transferred to the client computer 500 etc. (S511), whereupon the sequence proceeds to a step S512.

Subsequently, the system control circuit 50 discriminates, through the communication unit 110 constituting the wireless communication I/F for the mobile telephone etc., whether the connection state with the packet network 700 has been disconnected (S512).

If the connection state with the packet network 700 has not been disconnected (S512), the sequence returns to the step S504. If it has been disconnected (S512), the system control circuit 50 executes a predetermined communication ending process on the communication function, including the communication unit 110 constituting the wireless communication I/F for the mobile telephone (S513), and terminates the image request response process routine S120.

As explained in the foregoing, the image request response process routine S120 enables the image pickup apparatus 100, in response to the image transmission request from the client computer 500, to transmit the requested image data to the client computer 500. In this operation, the client computer 500 refers to the management information of the open images of the image pickup apparatus 100, stored in the image gateway 400 and opened on the internet, and sends the request directly to the image pickup apparatus 100, thereby achieving efficient transmission and reception of information.

<Function of Image Gateway (Image Management Apparatus) 400>

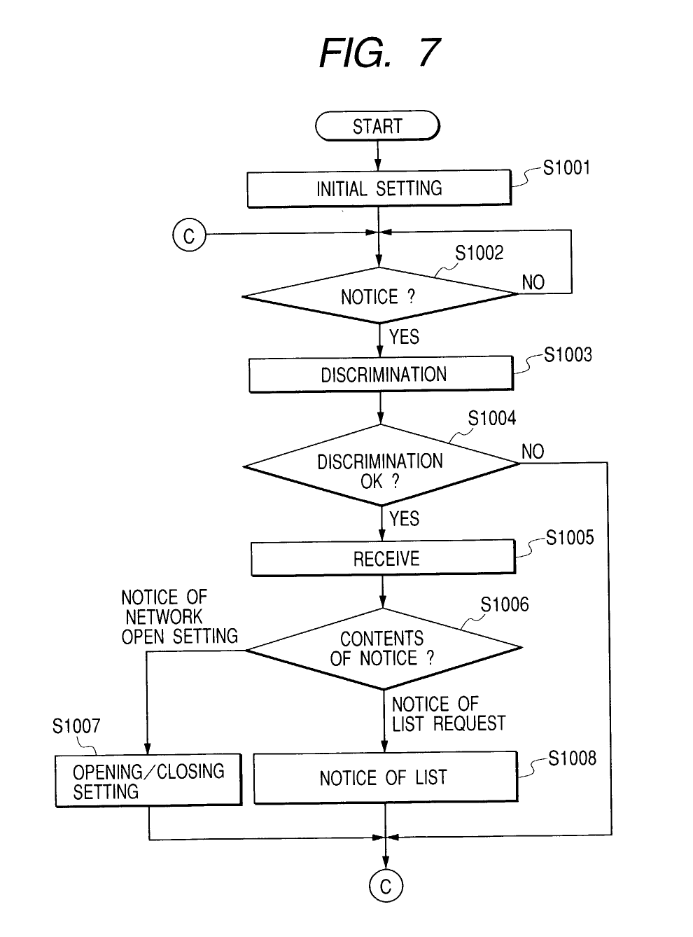

In the following there will be explained the function of the image gateway 400, with reference to FIG. 7, which is a flow chart of a main routine of the image gateway 400.

In response to the start of power supply in the image gateway 400, the control unit 402 executes initialization of flags, registers and control variables, then reads control programs such as an operating system stored in a part of the area of the hard disk 426 into the DRAM 410 through the low-speed bus 424, bus bridge 422, high-speed bus 412 and bus bridge 408 provided with the memory controller function, and executes such programs after reading a predetermined amount into the cache memory 406 through the bus bridge 408 having the memory controller function. Thus the control unit 402 initializes various parts of the image gateway 402 (S1001).

Subsequently, the control unit 402 discriminates whether a command etc. has been informed from the image pickup apparatus 100 or from the client computer 500 etc. (S1002).

If the step S1002 identifies that a command etc. has been informed, the control unit 402 executes identification and verification of the image pickup apparatus 100 or the client computer 500 etc. which has sent the command etc. (S1003), and, if the identification indicates that the informed command etc. has a problem for reception (S1004), the sequence returns to the step S1002.

If the identification indicates that the informed command etc. has no problem for reception (S1004), the sequence proceeds to a step S1005. The identification and verification of the image pickup apparatus 100 or the client computer 500 etc. which has transmitted the command etc. can be achieved from the identification management information stored in the hard disk 426 of the image gateway 400.

Then the control unit 402 receives the command etc. informed from the image pickup apparatus 100 or the client computer 500 etc. (S1005), and judges the content of the informed command etc (S1006).

If the content of the received command etc. is identified as a command for setting the open/close state of the image registered from the image pickup apparatus 100 (S1006), there is executed an open/close setting process of rewriting the open image list according to the informed command and storing the simultaneously informed thumbnail image etc. in the hard disk of the HDD 426, whereupon the sequence returns to the step S1002.

If the content of the command etc. received in the step S1005 is identified as a command requesting the open image list from the image pickup apparatus 100 or the client computer 500 etc. (S1006), the open image list of the image pickup apparatus 100, stored in the predetermined area of the hard disk 426, is transmitted to the requester (S1008), whereupon the sequence returns to the step S1002.

The image pickup apparatus 100, having received the aforementioned open image list, displays it on the image display unit 28 and utilizes for confirming the open/close setting. Also the client computer 500, having received the aforementioned open image list, can browse the open images of the image pickup apparatus 100 by the image gateway 400, and can thereafter request the desired image from the image pickup apparatus 100.

In the first embodiment of the present invention, as explained in the foregoing, it is rendered possible to automatically set whether or not to open the photographed image on the internet according to whether the user interface on the display unit 54 of the image pickup apparatus 100 and/or the image display unit 28 is set at a simple user interface for the beginner users or at a detailed user interface for the skilled users, there by avoiding a drawback that the image is erroneously opened by the beginner user.

On the other hand, if the setting is made at the detailed user interface for the skilled users, it is rendered possible, by the manipulation on the user interface of the image pickup apparatus 100, to change the setting of the management information for the registered images of the image pickup apparatus 100, stored in the image gateway 400 and opened on the internet, thereby achieving the setting of open/close state at any time.

As explained in the foregoing, the first embodiment is effective in improving the operability and preventing the erroneous operation by selecting modes according to the skill level of each user.

(Second Embodiment)

<Configuration of Image Pickup Apparatus 100>

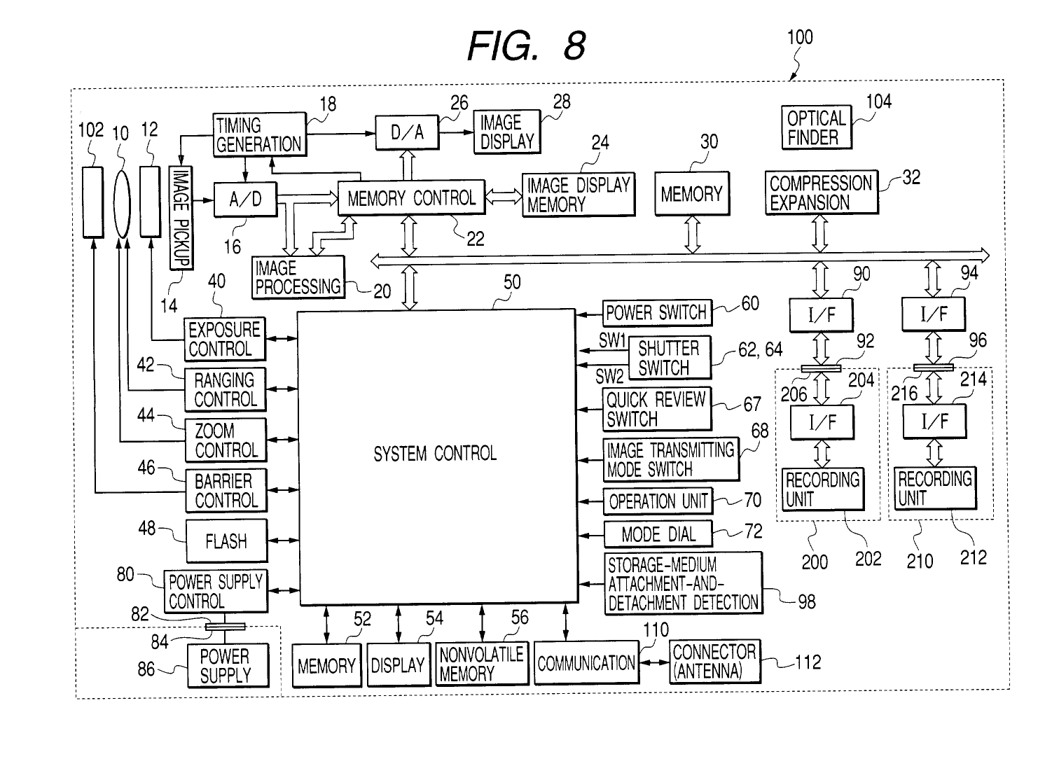

FIG. 8 shows the configuration of the image pickup apparatus 100 in a second embodiment of the present invention.

Referring to FIG. 8, blocks therein represented by numbers corresponding to those of the image pickup apparatus 100 shown in FIG. 2 are equivalent thereto in configuration and function, and will not be explained further.

The image pickup apparatus 100 shown in FIG. 8 is further provided with a quick review switch 67 and an image transmission mode switch 68.

The quick review switch 67 is used for setting a quick review function, for automatically reproducing the photographed image data on the image display unit 28 immediately after the photographing operation. The image transmission mode switch 68 sets whether or not to transmit the photographed image to the image gateway 400.

<Function of Image Pickup Apparatus 100>

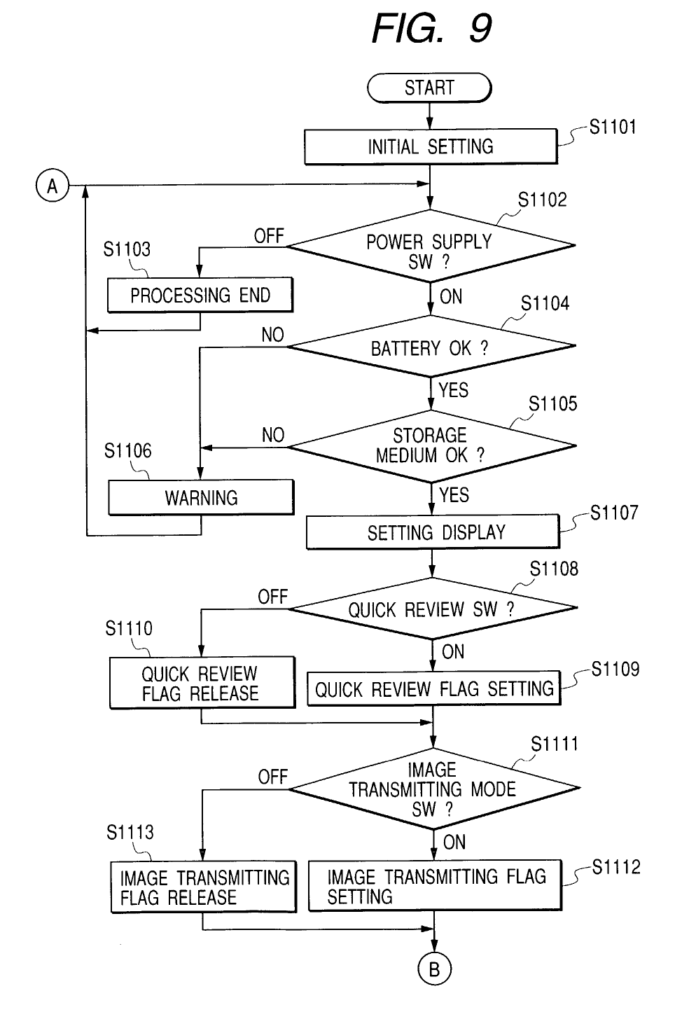

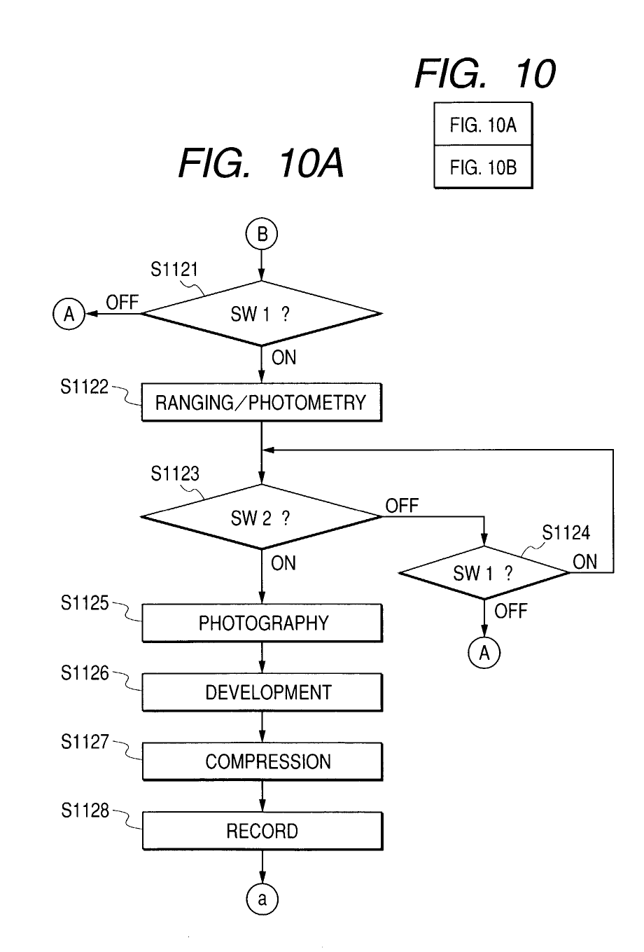

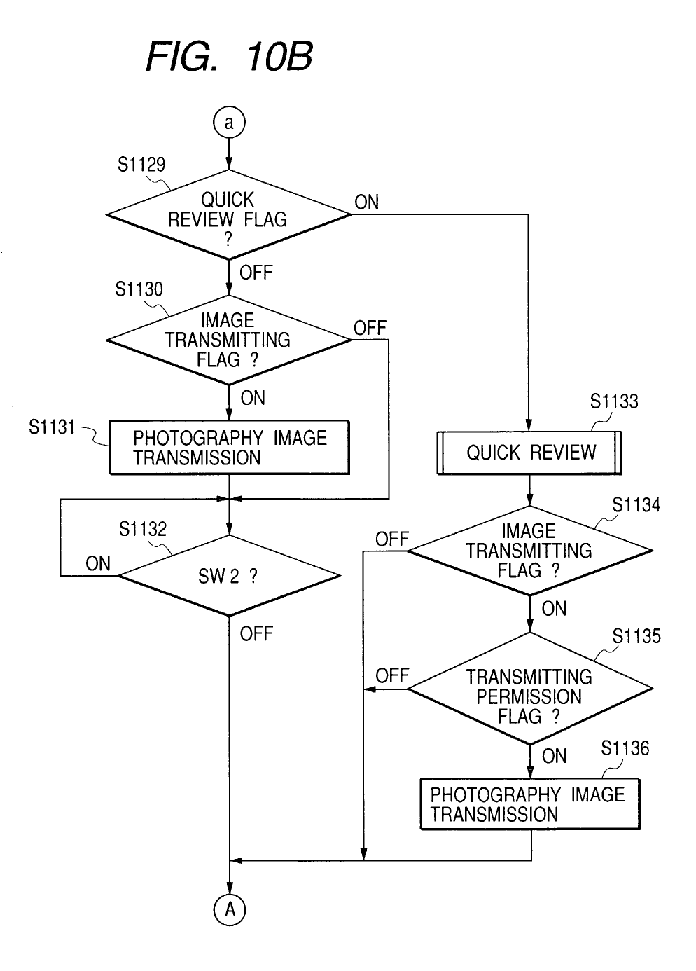

In the following there will be explained the function of the image pickup apparatus 100 in the second embodiment of the present invention, with reference to FIGS. 9, 10A and 10B, which are flow charts of a main routine of the image pickup apparatus 100.

In response to the start of power supply, for example by a battery exchange, the system control circuit 50 executes initialization of flags and control variables, and of various units of the image pickup apparatus 100 (S101).

The system control circuit 50 judges the set position of the power supply switch 60, and, if set at a power supply off state (S1102), executes a predetermined end process such as changing the display of the display units to an end state, recording the parameters, set values and set mode including the flags and control variables in the non-volatile memory 56, and causing the power supply control unit 80 to turn off the unnecessary power supply to various units of the image pickup apparatus 100 including the image display unit 28 (S1103), whereupon the sequence returns to the step S1102.

If the power supply switch 60 is set at a power supply on state (S1102), the sequence proceeds to a step S1104. The system control circuit 50 causes the power supply control unit 80 to judge whether the remaining capacity and the operation status of the power supply 86, composed of a battery or the like, have a problem in the function of the image pickup apparatus 100 (S1104), and, if there is any problem, it causes the display unit 54 to provide a predetermined warning display by an image or voice (S1106), whereupon the sequence returns to S1102.

If there is no problem in the power supply 86 (S1104), the sequence proceeds to a step S1105. Then the system control circuit 50 judges whether the operation status of the recording medium 200 or 210 has any problem on the function of the image pickup apparatus 100, particularly on the recording-reproducing operation of the image data on the recording medium (S1105), and, in case of any problem, it causes the display unit 54 to provide a predetermined warning display by an image or by voice (S1106), whereupon the sequence returns to the step S1102.

If the operation status of the recording medium 200 or 210 has no problem (S1105), the sequence proceeds to a step S1107. The system control circuit 50 executes display of various set states of the image pickup apparatus 100, utilizing an image or voice by the display unit 54. If the image display of the image display unit 28 is turned on, such image display unit 28 is also used for displaying the various set states of the image pickup apparatus 100 by an image or voice (S1107).

Subsequently, the system control circuit 50 checks the set state of the quick review switch 66 (S1108), and, if it is turned on, a quick review flag is set (S1109), but, if it is turned off, the quick review flag is reset (S1110), whereupon the sequence proceeds to a step S1111.

The quick review switch 66 allows to set whether or not to automatically reproduce the image data photographed by the image pickup apparatus 100 on the image display unit 28 immediately after the photographing operation, thereby confirming the photographed content. The state of the quick review flag is stored in the internal memory of the system control circuit 50 or in the memory 52.

Subsequently, the system control circuit 50 checks the set state of the image transmission mode switch 68 (S1111), and, if the image transmission mode is turned on, an image transmission flag is set (S1112), but, if it is turned off, the image transmission flag is reset (S1113), whereupon the sequence proceeds to a step S1121 shown in FIGS. 10A and 10B.

The image transmission mode switch 68 allows to set whether or not to register information (image data, thumbnail image, file name etc.) on the image data photographed by the image pickup apparatus 100 by transmission to the image gateway 400. The state of the image transmission flag is stored in the internal memory of the system control circuit 50 or in the memory 52.

If the system control circuit 50 identifies that the shutter switch SW1 is not depressed (S1121), the sequence returns to the step S1102. If the shutter switch SW1 is depressed (S1121), the system control circuit 50 executes a range measuring process to focus the photographing lens 10 at an object, and a light measuring process to determine the diaphragm stop value and the shutter time (S1122). A flash setting is also executed if required in the light measuring process.

Then, if the shutter switch SW2 is not depressed (S1123) and the shutter switch SW1 is released (S1124), the sequence returns to the step S1102. If the shutter switch SW2 is depressed (S1123), the system control circuit 50 executes a photographing process for obtaining an image by the image pickup device 12 (S1125).

After the photographing process S1125, the system control circuit 50 reads the photographed image data stored in the memory 30, then executes a development process such as predetermined pixel interpolation process and color conversion process utilizing the memory control circuit 22 and, if necessary, the image processing circuit 20, and stores the image data after the development process in a predetermined area of the memory 30 (S1126), whereupon the sequence proceeds to a step S1127.

Then the system control circuit 50 reads the image data stored in the predetermined area of the memory 30, and executes a compression process according to the set compression mode, utilizing the compression-expansion circuit 32 (S1127), whereupon the sequence proceeds to a step S1128. Then the system control circuit 50 reads the compressed image data stored in the memory 30 and executes recording in the recording medium 200 or 210 (S1128).

The system control circuit 50 judges the set state of the quick review flag stored in the internal memory of the system control circuit 50 or in the memory 52 (S1129), and, if the quick review flag is reset, the sequence proceeds to a step S1130, but, if the quick review flag is set (S1129), the sequence proceeds to a step S1133.

Then the system control circuit 50 judges the set state of the image transmission flag stored in the internal memory of the system control circuit 50 or in the memory 52 (S1130), and, if the image transmission flag is reset, the sequence proceeds to a step S1132. In this case, since the image transmission flag is reset, there is not executed the registration by transmitting the information on the photographed image to the image gateway 400.

If the image transmission flag is set (S1130), the system control circuit 50 executes registration by transmitting the information on the photographed image, stored in the memory 30 or recorded in the recording medium 200 or 210, to the image gateway 400 (S1131), and the sequence proceeds to a step S1132. In this case, since the quick review flag is reset in the step S1129, there is not executed the quick review display of automatically reproducing the photographed image on the image display unit 28 for confirming the content of photographing, and all the related information is registered in the image gateway 400 for each photographed image.

As explained in the foregoing, if the image pickup apparatus 100 is set at such a state of executing transmission immediately after the photographing operation, the system control circuit 50 can register the information on the photographed image data, which are photographed and stored in the memory 30 or recorded in the recording medium 200 or 210, in the image gateway 400 immediately after the photographing operation. The system control circuit 50 repeats the current process until the shutter switch SW2 is released.

When the shutter switch SW2 is released (S1132), the system control circuit 50 terminates a series of the photographing operations, whereupon the sequence returns to the step S1102.

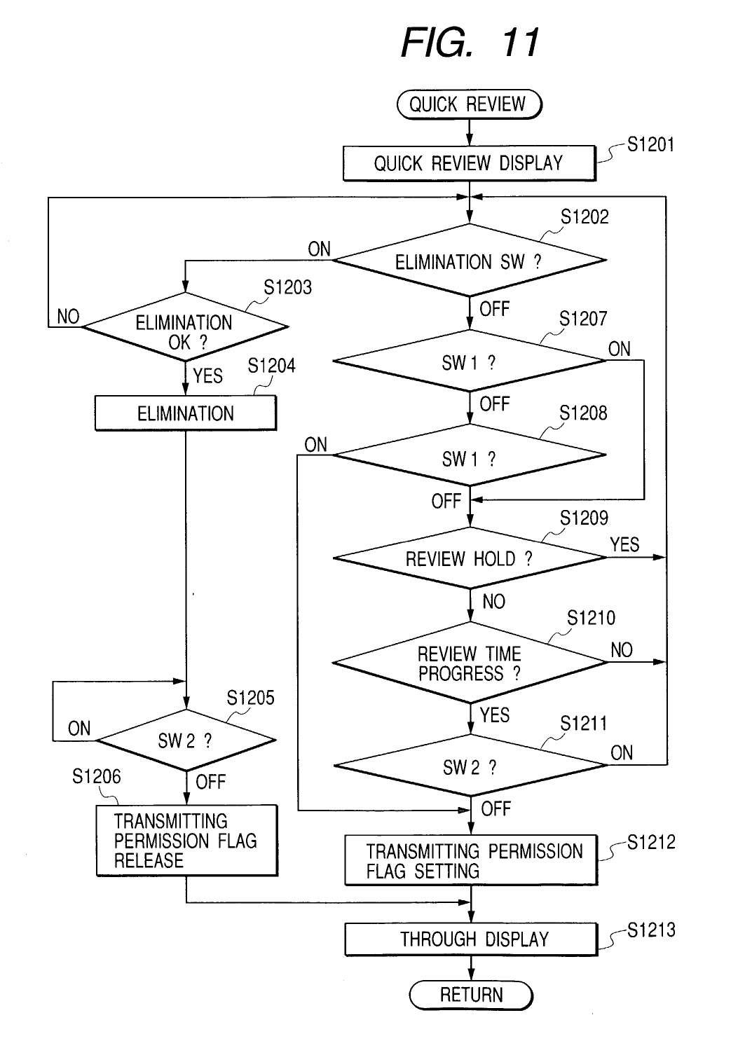

Also in a state where the quick review flag is set in the step S1129, the system control circuit 50 executes a quick review process S1133 of automatically reproducing the photographed image on the image display unit 28, and, after the process, the sequence proceeds to a step S1134. The details of the quick review process S1133 will be explained later with reference to FIG. 11.

The system control circuit 50 judges the set state of the image transmission flag stored in the internal memory of the system control circuit 50 or in the memory 52 (S1134), and, if the image transmission flag is reset, the system control circuit 50 terminates a series of the photographing operations and the sequence returns to the step S1102. In this case, since the image transmission flag is reset, there is not executed the transmission of the information on the photographed image to the image gateway 400.

If the image transmission flag is set (S1134), the system control circuit 50 judges the set state of a transmission permission flag stored in the internal memory of the system control circuit 50 or in the memory 52 (S1135). If the transmission permission flag is reset (S1135), the system control circuit 50 terminates a series of the photographing operations and the sequence returns to the step S1102.

In this case, the image transmission flag is set, but, as a result of the quick review process routine S1133, the user of the image pickup apparatus 100 has determined the photographed image, confirmed in the quick review display, as unnecessary and has executed an erasing operation whereby the transmission permission flag has been reset. Also in this case, there is not executed the transmission of the information on the photographed image to the image gateway 400. The setting of the image transmission permission flag will be explained later in connection with the explanation of the quick review process.

In a situation where the image transmission flag is set in the step S1134 and the transmission permission flag is also set (S1135), the system control circuit 50 reads the photographed image data stored in the memory 30 or recorded in the recording medium 200 or 210 and registers the related information by transmission to the image gateway 400 through the communication unit 110, connector or antenna 112, packet network 700 and network 702 (S1136), whereupon the sequence returns to the step S1102.

In the present embodiment, as explained in the foregoing, if there is selected the setting for quick review display, even if the setting for transmitting the photographed image data to the image gateway 400 is selected, it is possible to register the photographed image in the image gateway 400 after confirming the result of the photographed image, so that the registration of the unnecessary image can be prevented.

FIG. 11 shows a detailed flow chart of the quick review process in the step S1133 in FIGS. 10A and 10B.

The system control circuit 50 reads the photographed image data stored in a predetermined area of the memory 30, and executes the quick review display process for automatically reproducing the image on the image display unit 28 through the memory control circuit 22 and the D/A converter 26 (S1201).

In the course of the quick review display process, the system control circuit 50 judges the state of an erasing switch provided in the operation unit 70 (S1202), and, if the erasing switch is off, the sequence proceeds to a step S1207. If the erasing switch is turned on (S1202), the system control circuit 50 causes the image display unit 28 to execute a display for confirming whether the erasing operation is to be executed.

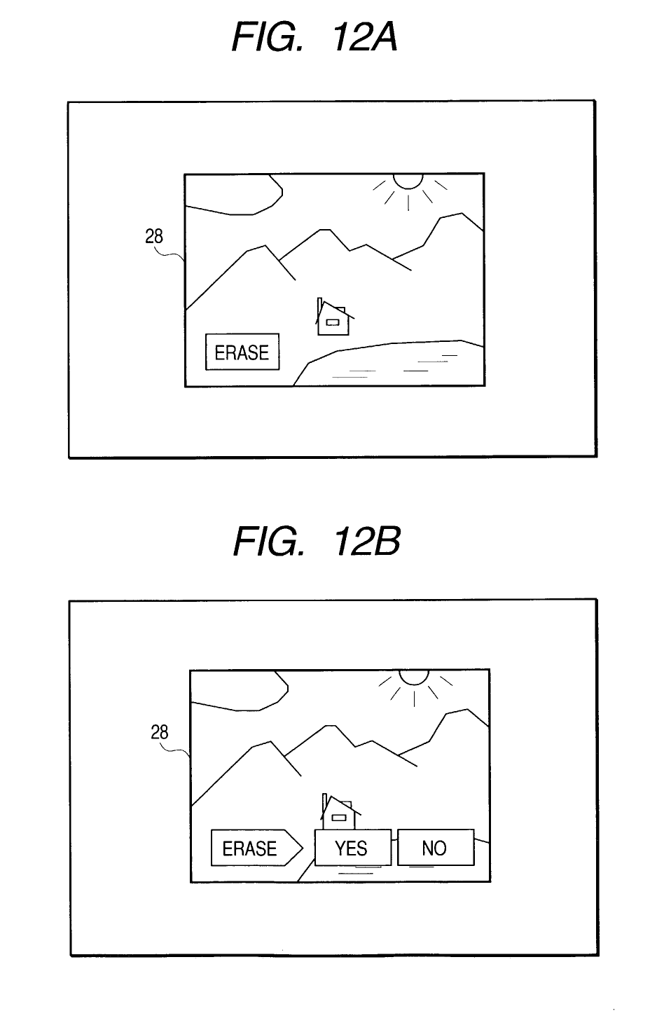

FIGS. 12A and 12B show an example of the display in this operation, wherein FIG. 12A shows a state of the display unit 28 for accepting erasure of an image in the course of quick review reproduction, and FIG. 12B shows an image for confirmation when the erasing switch is depressed.

Then, there is discriminated the state of an erasure confirming switch provided in the operation unit 70 (S1203).

If the erasure confirming switch is off (S1203), the sequence returns to the step S1202. If the erasure confirming switch is on (S1203), the system control circuit 50 erases the photographed image data which are once stored in the recording medium 200 or 210 in the step S128 (S1204), and the sequence proceeds to a step S1205. If the shutter switch SW2 has not been released (S1205), the system control circuit 50 turns off the transmission permission flag (S1206) and the sequence proceeds to a step S1213.

Thus, even when there is selected a setting for transmitting the photographed image data from the image pickup apparatus 100 to the image gateway 400, if the photographed image is erased as a result of confirmation of the photographed image in the quick review process, the transmission permission flag is reset to avoid registration of an image that need not be registered in the image gateway 400.

The state of the transmission permission flag is stored in the internal memory of the system control circuit 50 or in the memory 52.

In case the shutter switch SW1 is released (S1207) and remains thereafter in a released state for a predetermined period (S1208), the situation is so estimated that the user of the image pickup apparatus 100 has completed the photographing operation and is in the course of confirming the photographed image by the quick review display, whereby the sequence proceeds to a step S1209. In case the shutter switch SW1 is released (S1207) and is thereafter depressed again (S1208), the situation is so estimated that the user of the image pickup apparatus 100 has terminated the quick review display and is preparing for a new photographing operation, whereby the sequence proceeds to a step S1212. If the shutter switch SW1 remains in the depressed state (S1207), the sequence proceeds to a step S1209.

The system control switch 50 judges the state of a review hold switch provided in the operation unit 70 (S1209), and, if it is set at a review hold state for continuing the quick review, the sequence returns to the step S1202 for continuing the quick review. If it is not set at the review hold state for continuing the quick review (S1209), the sequence proceeds to a step S1210.

The system control circuit 50 discriminates whether there has elapsed a continuing time of the quick review display, set by a review time setting switch provided in the operation unit 70 (S1210), and, if such review time has not elapsed, the sequence returns to the step S1202 to continue the quick review. If the continuing time of the quick review display has elapsed (S1210), the sequence proceeds to a step S1211.

Then, if the system control circuit 50 identifies that the shutter switch SW2 is depressed (S1211), the sequence returns to the step S1202. If the shutter switch SW2 is not depressed (S1211), the system control circuit 50 sets the transmission permission flag (S1212) and the sequence proceeds to a step S1213.

Thus, in case of a setting of transmitting the photographed image data from the image pickup apparatus 100 to the image gateway 400, if the photographed image is decided to be registered by the confirmation thereof through the quick review, it is possible, by setting the transmission permission flag, to transmit only the image information to be transmitted from the image pickup apparatus 100 to the image gateway 400. The state of the transmission permission flag is stored in the internal memory of the system control circuit 50 or in the memory 52.

The system control circuit 50 sets the image display unit 28 at a through display state for displaying the photographed image data in succession (S1213) and terminates the quick review process routine S1133. In the through display state, an electronic viewfinder function is realized by displaying the data, written in succession into the image display memory 24 through the image pickup device 12, A/D converter 16, image processing circuit 20 and memory control circuit 22, in succession on the image display unit 28 through the memory control circuit 22 and the D/A converter 26.

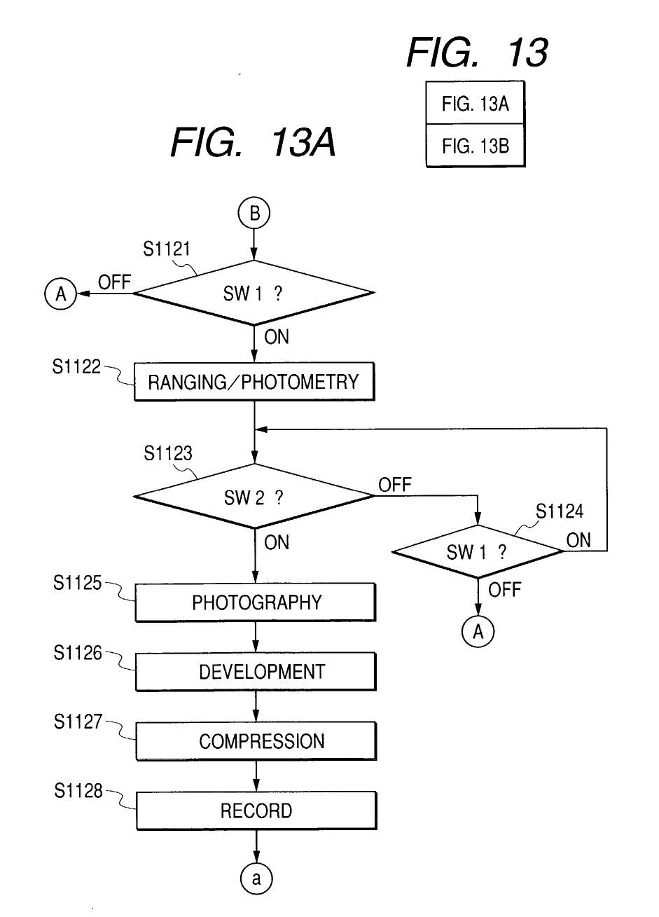

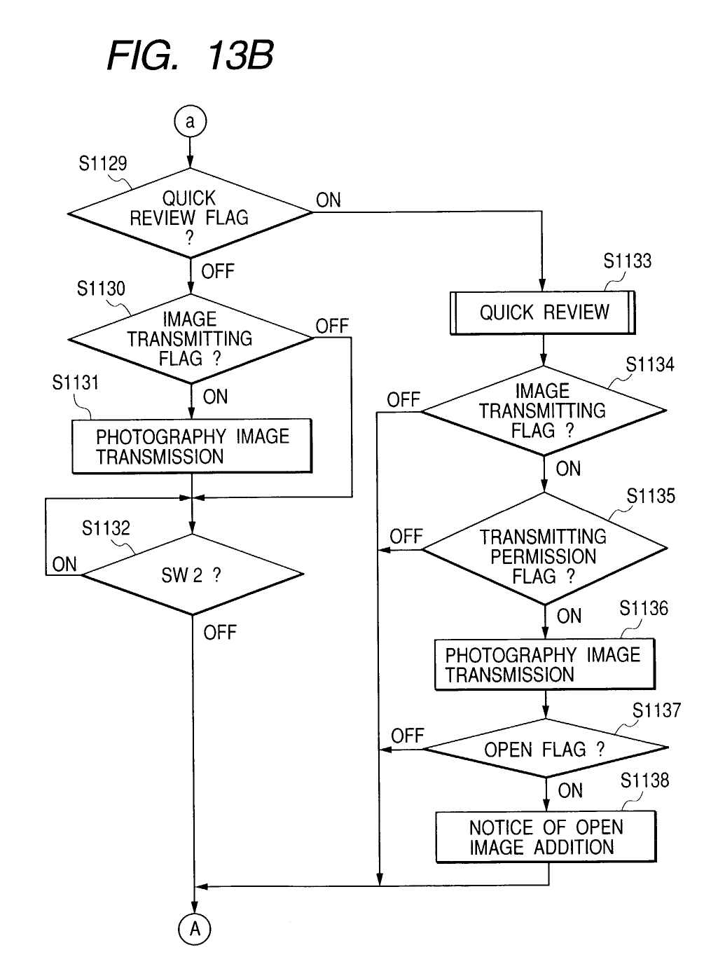

In the second embodiment, it is also possible to execute a process of the image pickup apparatus 100 shown in flow charts in FIGS. 9, 13A and 13B. In the flow chart shown in FIGS. 13A and 13B, there can be added a setting for opening the image registered in the image gateway 400, in addition to the processes shown in FIGS. 10A and 10B.

More specifically, the process from the step S1121 to the step S1135 in FIGS. 13A and 13B is same as that shown in FIGS. 10A and 10B and will not be explained further. Thereafter, in a step S1136, after the registration of the information on the photographed image by transmission to the image gateway 400, the system control circuit 50 judges the set open state of the image stored in the internal memory of the system control circuit 50 or in the memory 52 (S1137). If an open flag in the management information of the image is reset (S1137), a series of photographing operations is terminated and the sequence returns to the step S1102, but, if the open flag is set (S1137), the system control circuit 50 informs the image gateway 400 of an addition of the corresponding image to the open setting (S1138), whereupon the sequence returns to the step S1102.

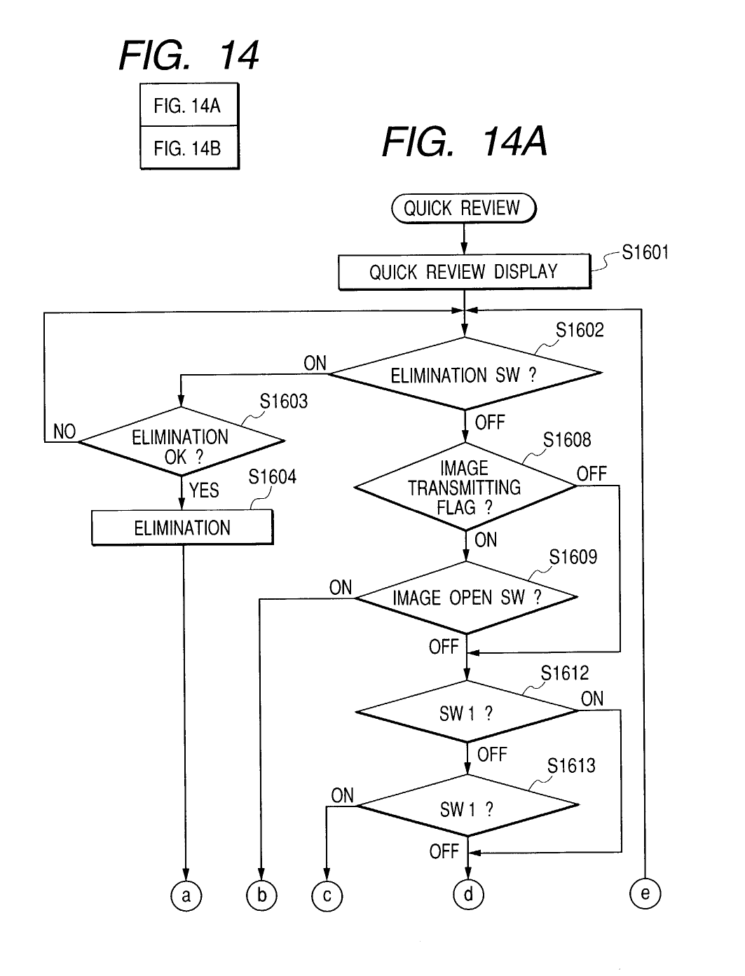

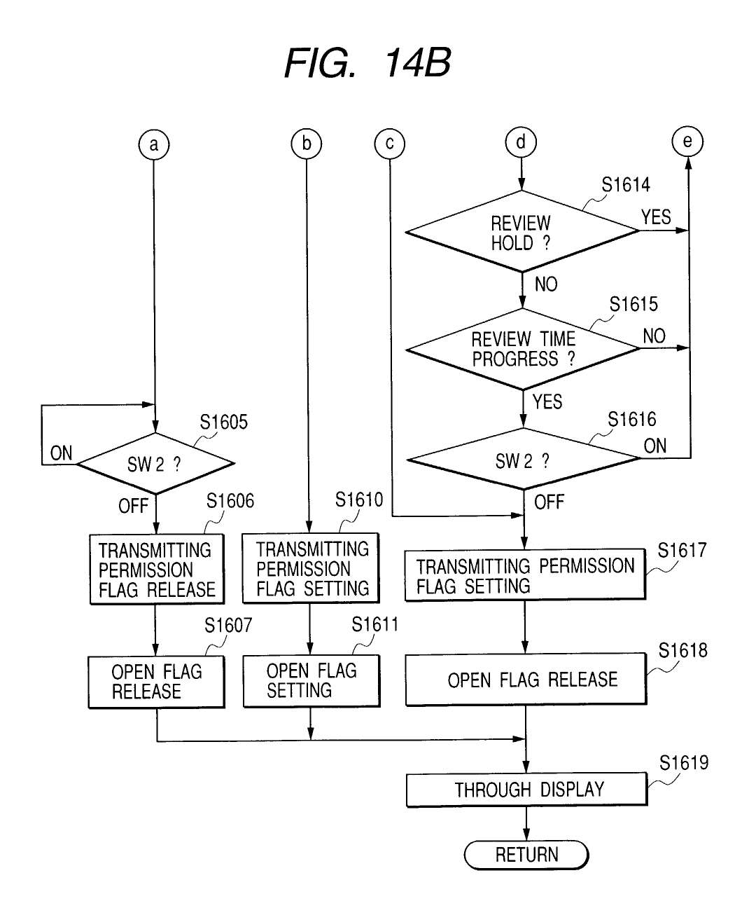

FIGS. 14A and 14B show detailed flow charts of the quick review process of S1133 in FIGS. 13A and 13B. The system control circuit 50 reads the photographed image data stored in the predetermined area of the memory 30, and executes the quick review display of automatically reproducing the image on the image display unit 28 through the memory control circuit 22 and the D/A converter 26 (S1601).

The system control circuit 50 judges the state of the erasing switch provided in the operation unit 70 (S1602), and, if the erasing switch is off, the sequence proceeds to a step S1608. If the erasing switch is on (S1602), the system control unit 50 causes the image display unit 28 to execute a display for confirming whether the erasure is to be executed, and judges the state of an erasure confirming switch provided in the operation unit 70 (S1603). If the erasure confirming switch is off (S1603), the sequence returns to the step S1602.

If the erasure confirming switch is on (S1603), the system control circuit 50 erases the photographed image data once recorded by the step S1128 in the recording medium 200 or 210 (S1604), and the sequence proceeds to a step S1605. The system control circuit 50 resets the transmission permission flag (S1606), also resets the open flag (S1607), and the sequence proceeds to a step S1619.

Thus, even in case of a setting for transmitting the information on the photographed image from the image pickup apparatus 100 to the image gateway 400, if the photographed image is erased as a result of confirmation by the quick review, the transmission permission flag is reset to prevent registration or opening of an image that need not be transmitted.

The system control circuit 50 judges the state of the image transmission flag stored in the internal memory of the system control circuit 50 or in the memory 52 (S1608), and, if the image transmission flag is reset, the sequence proceeds to a step S1612. If the image transmission flag is set (S1608), the system control circuit 50 judges the set state of an image open switch provided in the operation unit 70 (S1609). If the image open switch is off (S1609), the sequence proceeds to a step S1612.

If the image open switch is on (S1609), the system control circuit 50 sets the transmission permission flag ((S1610) and also sets the open flag (1611), whereupon the sequence proceeds to a step S1619.

It is thus rendered possible, after confirming the result of the photographed image, to register the information on the photographed image by transmission to the image gateway 400 and also to set whether or not to open such information from the image gateway 400 to the client computer 500 etc., whereby there can be avoided a situation in which the transmitted image data becomes inappropriate for opening immediate after the transmission of the image data. The states of the transmission permission flag and the open flag are stored in the internal memory of the system control circuit 50 or in the memory 52.

FIGS. 15A and 15B show an example of the display content of the image display unit 28 in the process of the steps S1602 to S1603 and in the step S1609, wherein FIG. 15A shows an image for confirming “erasure” during the quick review reproduction, and FIG. 15B shows an image for confirming “opening” during the quick review reproduction.

Then, in case the shutter switch SW1 is released (S1612) and remains thereafter in a released state for a predetermined period (S1613), the situation is so estimated that the user of the image pickup apparatus 100 has completed the photographing operation and is in the course of confirming the photographed image by the quick review display, whereby the sequence proceeds to a step S1614. In case the shutter switch SW1 is released (S1612) and is thereafter depressed again (S1613), the situation is so estimated that the user of the image pickup apparatus 100 has terminated the quick review display and is preparing for a new photographing operation, whereby the sequence proceeds to a step S1617.

If the shutter switch SW1 remains in the depressed state (S1613), the sequence proceeds to a step S1614. The system control switch 50 judges the state of a review hold switch provided in the operation unit 70 (S1614), and, if it is set at a review hold state for continuing the quick review state, the sequence returns to the step S1602 for continuing the quick review.

If it is not set at the review hold state for continuing the quick review state (S1614), the sequence proceeds to a step S1615. The system control circuit 50 discriminates whether there has elapsed a continuing time of the quick review display, set by a review time setting switch provided in the operation unit 70 (S1615), and, if such review time has not elapsed, the sequence returns to the step S1602 to continue the quick review. If the continuing time of the quick review display has elapsed (S1615), the sequence proceeds to a step S1616.

Then, if the system control circuit 50 identifies that the shutter switch SW2 is depressed (S1616), the sequence returns to the step S1602. If the shutter switch SW2 is not depressed (S1616), the system control circuit 50 sets the transmission permission flag (S1617) and the sequence proceeds to a step S1619.

Thus, in case of a setting of transmitting the photographed image data from the image pickup apparatus 100 to the image gateway 400, if the photographed image is decided to be registered by the confirmation thereof through the quick review, it is possible, by setting the transmission permission flag, to transmit only the image information to be transmitted from the image pickup apparatus 100 to the image gateway 400.

Also in case the image data registered in the image gateway 400 are inappropriate for opening from the image gateway 400 to the client computer 500 etc., a closed setting can be selected at the confirmation of the photographed image, thereby avoiding problems relating to privacy or security. The state of the transmission permission flag is stored in the internal memory of the system control circuit 50 or in the memory 52.

The system control circuit 50 sets the image display unit 28 at a through display state for displaying the photographed image data in succession (S1619) and terminates the quick review process routine S1133. In the through display state, an electronic viewfinder function is realized by displaying the data, written in succession into the image display memory 24 through the image pickup device 12, A/D converter 16, image processing circuit 20 and memory control circuit 22, in succession on the image display unit 28 through the memory control circuit 22 and the D/A converter 26.

In the second embodiment, as explained in the foregoing, in case the image pickup apparatus 100 is so set as to transmit the information on the photographed image immediately after the photographing operation, the system control circuit 50 can register the information on the image photographed and stored in the memory 30 or recorded in the recording medium 200 or 210 in the image gateway 400 immediately after the photographing operation.

Also in case of such a setting as to transmit the information on the photographed image from the image pickup apparatus 100 to the image gateway 400, if the photographed image is erased as a result of confirmation of the photographed image by the quick review, the transmission permission flag is reset to avoid registration of the image not required for transmission, in the image gateway 400.

Also in case of a setting to transmit the information on the photographed image from the image pickup apparatus 100 to the image gateway 400, if the photographed image is decided to be transmitted by the confirmation thereof through the quick review, the transmission permission flag is set whereby only the image to be transmitted can be registered in the image gateway 400.

Furthermore, even in case of a setting to transmit the information on the photographed image to the image gateway 400, if the setting for quick review display is selected, it is rendered possible, after confirmation of the result of the photographed image, to transmit the information on the photographed image to the image gateway 400 and also to set whether or not to open such information from the image gateway 400 to the internet 600, so that it is possible to avoid a situation where the transmitted image becomes inappropriate for opening immediately after the transmission.

(Third Embodiment)

<Configuration of Image Pickup Apparatus 100>

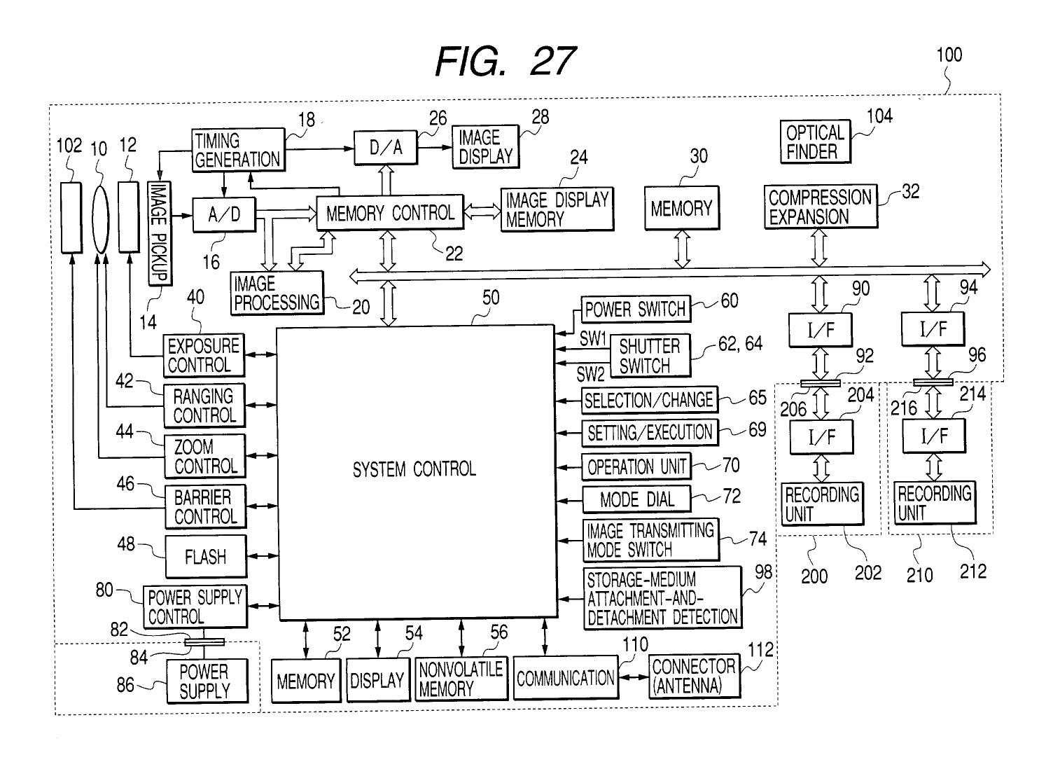

FIG. 27 shows the configuration of the image pickup apparatus 100 in a third embodiment of the present invention.

Referring to FIG. 27, blocks therein represented by numbers corresponding to those of the image pickup apparatus 100 shown in FIG. 2 are equivalent thereto in configuration and function, and will not be explained further.

The image pickup apparatus 100 shown in FIG. 27 is further provided with a selection/change switch 65, a determination/execution switch 69 and an image transmission mode switch 74.

The selection/change switch 65 is used for selecting and changing various functions in the execution of photographing and reproduction in a panorama mode etc. The determination/execution switch 69 determines and executes various functions in the execution of photographing and reproduction in the panorama mode etc. The image transmission mode switch 74 sets whether or not to transmit the information on the photographed image to the image gateway 400.

<Function of Image Pickup Apparatus 100>

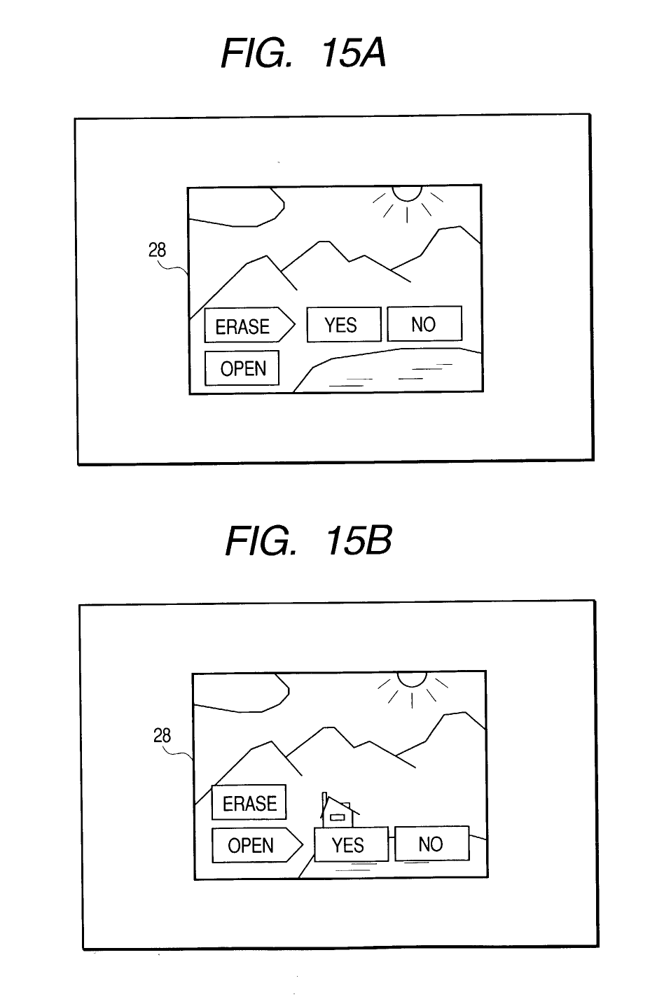

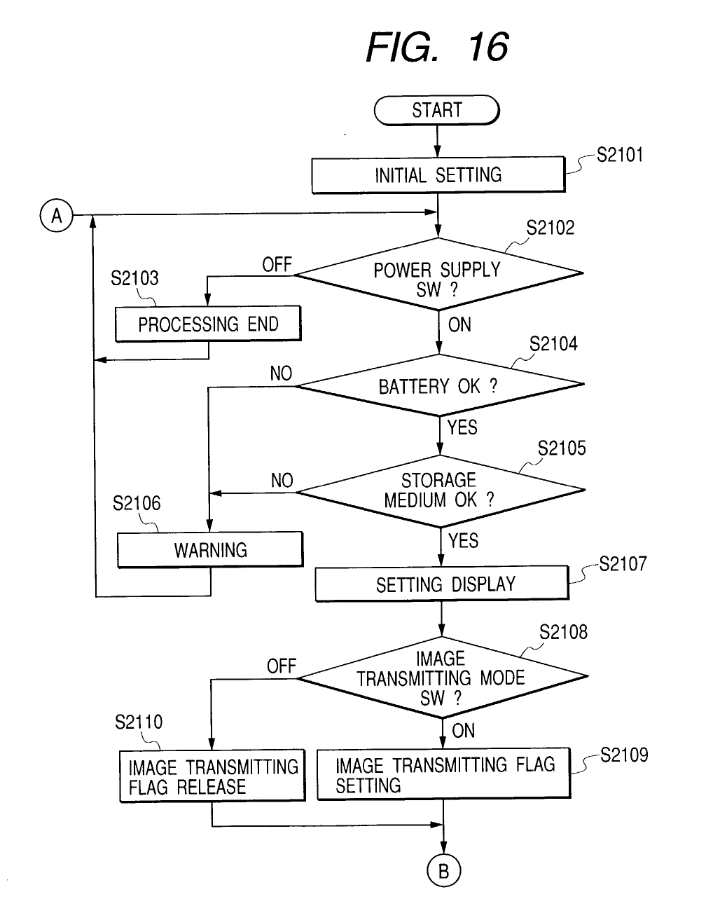

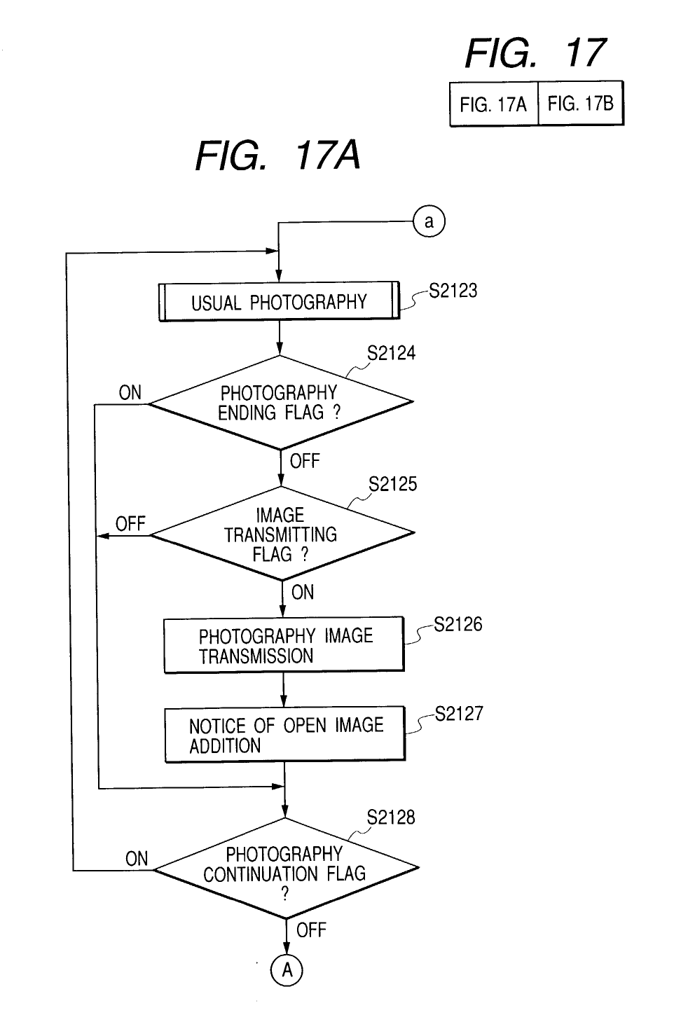

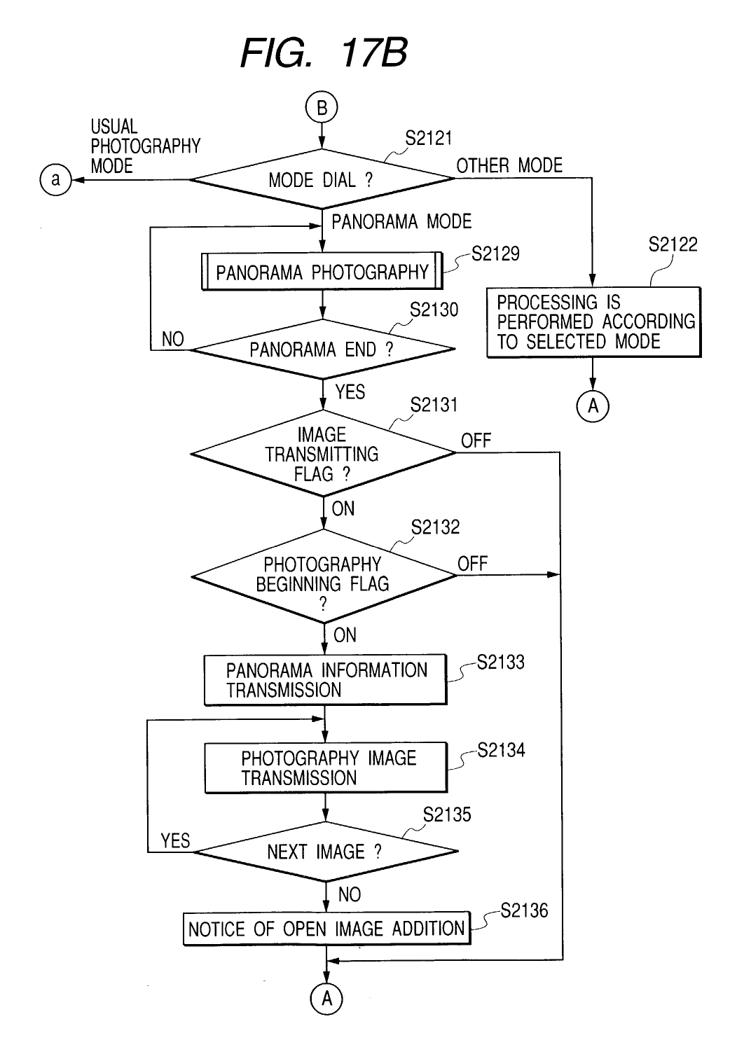

In the following there will be explained the function of the image pickup apparatus 100 in the third embodiment of the present invention, with reference to FIGS. 16, 17A and 17B, which are flow charts of a main routine of the image pickup apparatus 100.

Referring to FIG. 16, in response to the start of power supply, for example by a battery exchange, the system control circuit 50 executes initialization of flags and control variables, and of various units of the image pickup apparatus 100 (S2101). The system control circuit 50 judges the set position of the power supply switch 60, and, if set at a power supply off state (S2102), executes a predetermined end process such as changing the display of the display units to an end state, recording the parameters, set values and set mode including the flags and control variables in the non-volatile memory 56, and causing the power supply control unit 80 to turn off the unnecessary power supply to various units of the image pickup apparatus 100 including the image display unit 28 (S2103), whereupon the sequence returns to the step S2102.

If the power supply switch 60 is set at a power supply on state (S2102), the sequence proceeds to a step S2104. The system control circuit 50 causes the power supply control unit 80 to judge whether the remaining capacity and the operation status of the power supply 86, composed of a battery or the like, have a problem in the function of the image pickup apparatus 100 (S2104), and, if there is any problem, it causes the display unit 54 to provide a predetermined warning display by an image or voice (S2106), whereupon the sequence returns to S2102. If there is no problem in the power supply 86 (S2104), the sequence proceeds to a step S2105.

Then the system control circuit 50 judges whether the operation status of the recording medium 200 or 210 has any problem on the function of the image pickup apparatus 100, particularly on the recording-reproducing operation of the image data on the recording medium (S2105), and, in case of any problem, it causes the display unit 54 to provide a predetermined warning display by an image or by voice (S2106), whereupon the sequence returns to the step S2102.

If the operation status of the recording medium 200 or 210 has no problem (S2105), the sequence proceeds to a step S2107. The system control circuit 50 executes display of various set states of the image pickup apparatus 100, utilizing an image or voice by the display unit 54. If the image display of the image display unit 28 is turned on, such image display unit 28 is also used for displaying the various set states of the image pickup apparatus 100 by an image or voice (S2107).

Subsequently, the system control circuit 50 checks the set state of the image transmission mode switch 74 (S2108), and, if the image transmission mode is turned on, an image transmission flag is set (S2109), but, if it is turned off, the image transmission flag is reset (S2110), whereupon the sequence proceeds to a step S2121.

The image transmission mode switch 74 allows to set whether or not to register the information on the image photographed by the image pickup apparatus 100, by transmission to the image gateway 400. The state of the image transmission flag is stored in the internal memory of the system control circuit 50 or in the memory 52.

Subsequently, in FIGS. 17A and 17B, if the mode dial 60 is set at a photographing mode (S2121), the sequence proceeds to a step S2123. It if it set at a panorama mode (S2121), the sequence proceeds to a step S2129. If the mode dial 60 is set at any other mode (S2121), the system control circuit 50 executes a process corresponding to the selected mode (S2122), and, after the process, the sequence returns to the step S2102.

The system control circuit 50 executes an ordinary photographing process including range/light measurement, photographing, development, compression and recording according to the manipulation of the shutter switches SW1, SW2 (S2123) and the sequence returns to a step S2124.

Then the system control circuit 50 checks the state of a photographing end flag stored in the internal memory of the system control circuit 50 or in the memory 52 (S2124), and, if the photographing end flag is set, it is identified that a new photographing operation has not been executed in the ordinary photographing process step S2123 and the sequence proceeds to a step S2128.

If the photographing end flag is reset (S2124), the system control circuit 50, estimating that a new photographing operation has been executed in the ordinary photographing process step S2123, judges the state of an image transmission flag stored in the internal memory of the system control circuit 50 or in the memory 52 (S2125). If the image transmission flag is reset, it is identified that a mode of transmitting the photographed image data to the image gateway 400 is not selected and the sequence proceeds to a step S2128.

If the image transmission flag is set (S2125), the system control circuit 50, identifying the selection of a mode of transmitting the photographed image data to the image gateway 400, reads the photographed image data stored in the memory 30 or recorded in the recording medium 200 or 210, then transmits such data to the image gateway 400 through the communication unit 110, connector or antenna 112, packet network 700 and network 702 (S2126), and informs the image gateway 400 of an addition to the open image through the packet network 700 and the network 702, whereupon the sequence proceeds to a step S2128.

In the ordinary photographing mode, as explained in the foregoing, both in the single and continuous photographing operations, the information on the photographed image is transmitted for each photographing operation to the image gateway 400 whereby the photographed image can be immediately registered in linkage with the photographing operation. It is thus rendered possible to register the photographed image from time to time without awaiting the completion of a series of continuous photographing operations, and to achieve transmission of the image information synchronized with the photographing operation.

The system control circuit 50 judges the state of a photographing continuation flag stored in the internal memory of the system control circuit 50 or in the memory 52 (S2128), and, if the photographing continuation flag is set, identifies a situation of continuing the photographing operation in the ordinary photographing process step S2123, whereby the sequence returns to the step S2123 to repeat the photographing process. If the photographing continuation flag is reset (S2128), the system control circuit 50 identifies a situation where a new photographing operation has been executed in the ordinary photographing process step S2123 but a next photographing operation is not executed in succession, and terminates the photographing process whereby the sequence returns to the step S2102.

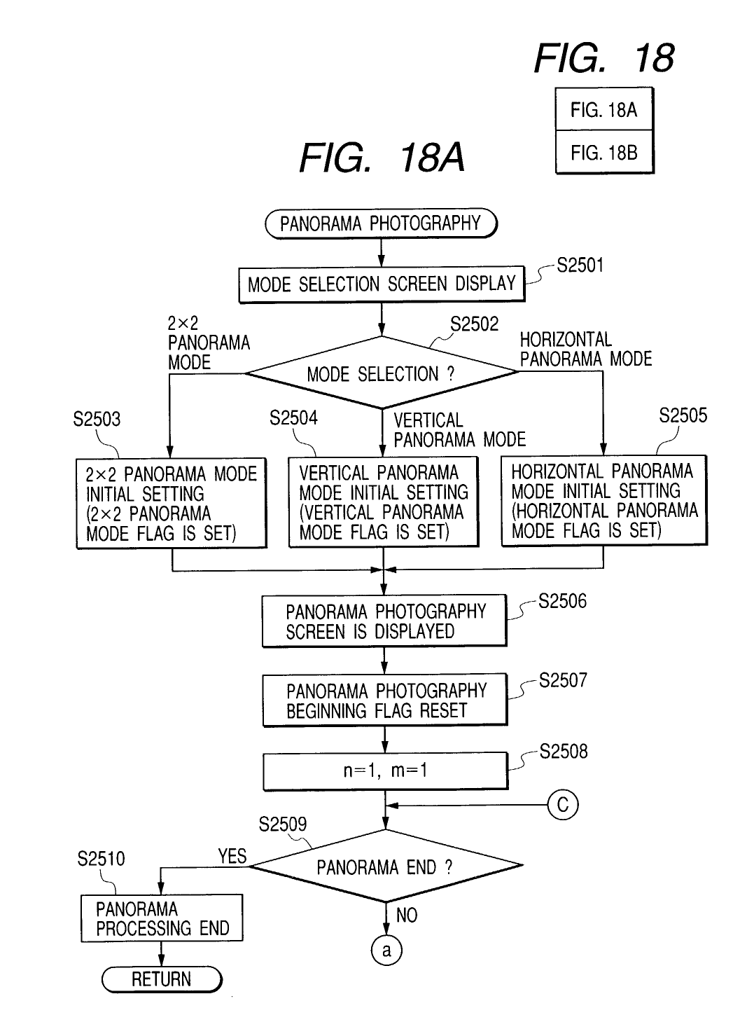

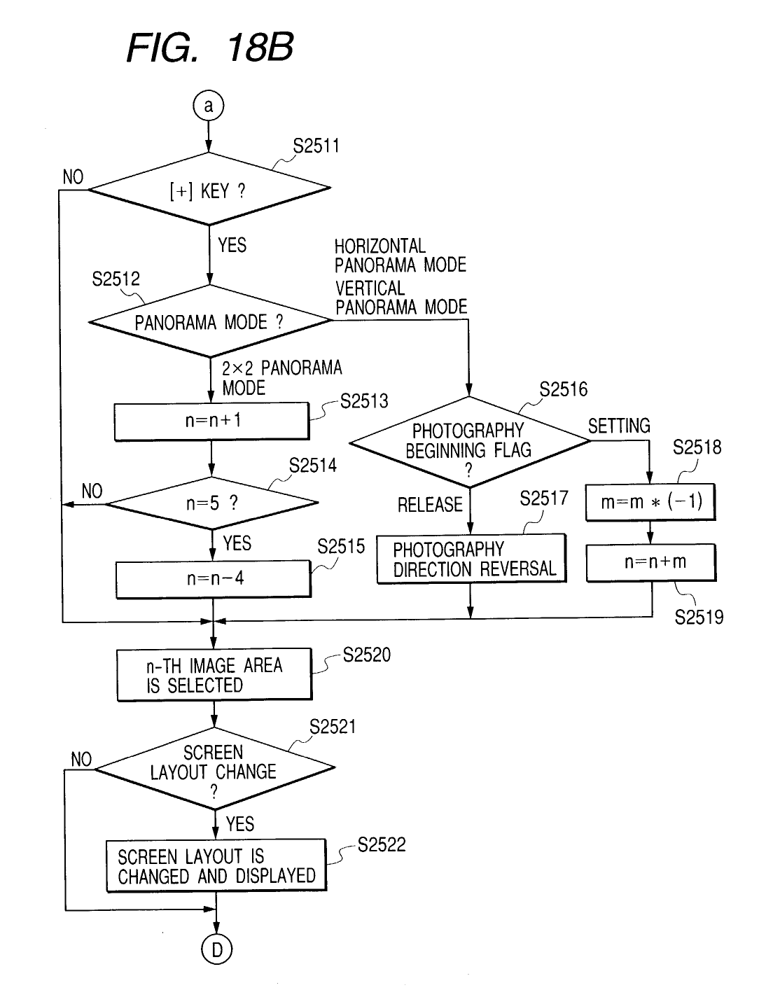

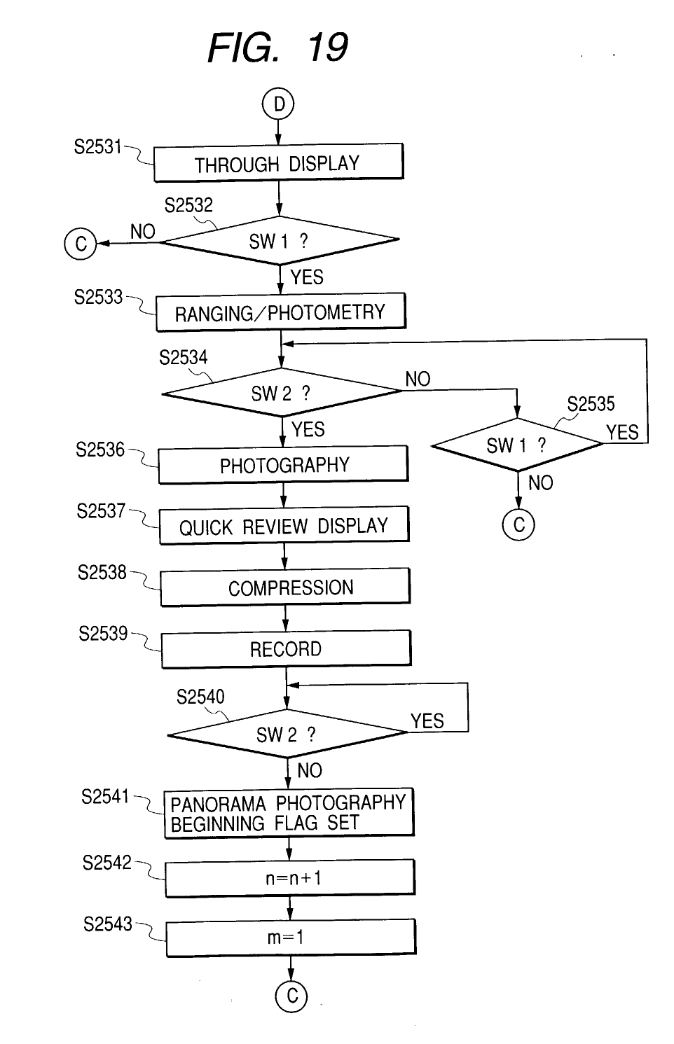

The system control circuit 50 executes a photographing process for a set of panorama images according to the selection of a 2×2 panorama mode, a vertical panorama mode or a horizontal panorama mode and the manipulation of the shutter switches SW1, SW2 (S2129), and the sequence returns to a step S2130. The details of the panorama photographing process S2129 will be explained later with reference to FIGS. 18A, 18B and 19.

The system control circuit 50 returns to the step S2129 to repeat the panorama photographing process S2129, until the panorama photographing process in the selected panorama mode is completed (S2130). When the panorama photographing process in the selected panorama mode is completed (S2130), the sequence proceeds to a step S2131. The system control circuit 50 judges the state of the image transmission flag stored in the internal memory of the system control circuit 50 or in the memory 52 (S2131), and, if the image transmission flag is reset, identifies that a mode of transmitting the photographed image data to the image gateway 400 is not selected, whereupon the sequence returns to the step S2102.

If the image transmission flag is set (S2131), the system control circuit 50, identifying the selection of a mode of transmitting the photographed image to the image gateway 400, judges the state of a panorama photographing start flag stored in the internal memory of the system control circuit 50 or in the memory 52 (S2132). If the panorama photographing start flag is reset, the system control circuit 50 identifies a situation where the panorama photographing is not executed in the panorama photographing process step S2129, and the sequence returns to the step S2102.

If the panorama photographing start flag is set, the system control circuit 50, identifying a situation where the panorama photographing has been executed in the panorama photographing process step S2129, transmits information relating to a set of image data of the executed panorama photographing operations to the image gateway 400, through the packet network 700 and the network 702 (S2133), then reads in succession the data of a set of panorama images stored in the memory 30 or recorded in the recording medium 200 or 210 and transmits the related image information in succession for registration (S2134, S2135).

Prior to the transmission of the photographed image data of a set of panorama images, the information relating to the set of the photographed image data of the set of panorama images is transmitted to facilitate collective storage and management of such set of panorama photographed images and the management information thereof, in the image gateway 400.

After the registration of a set of panorama photographed images (S2135), the system control circuit 50 informs the image gateway 400 of an addition to the open images (S2136), and, after the transmission of a set of the panorama photographed images and of the information relating thereto, the sequence returns to the step S2102.

Thus, in the panorama photographing mode, after the execution of a set of panorama photographing operations, the information relating to the photographed set of the panorama images is transmitted to and registered in the image gateway 400, whereby the image data of a set of plural images and the information relating to such image data can be securely managed and delivered in the image gateway 400. Also it is rendered possible to browse or refer to such set of panorama images in the client computer 500 through the image gateway 400.

FIGS. 18A, 18B and 19 show detailed flow charts of a panorama photographing process in the step S2129 shown in FIGS. 17A and 17B.

The system control circuit 50 displays a panorama mode selection image on the image display unit 28 (S2501). The user of the image pickup apparatus 100 can select any one of plural panorama photographing modes, by looking at the panorama mode selection image displayed on the image display unit 28.

The panorama photographing modes includes a 2×2 panorama mode, a horizontal panorama mode and a vertical panorama mode, which respectively provide, by superposing plural photographed images, a two-dimensionally enlarged panorama image, a panorama image expanded in the horizontal direction and a panorama image expanded in the vertical direction.

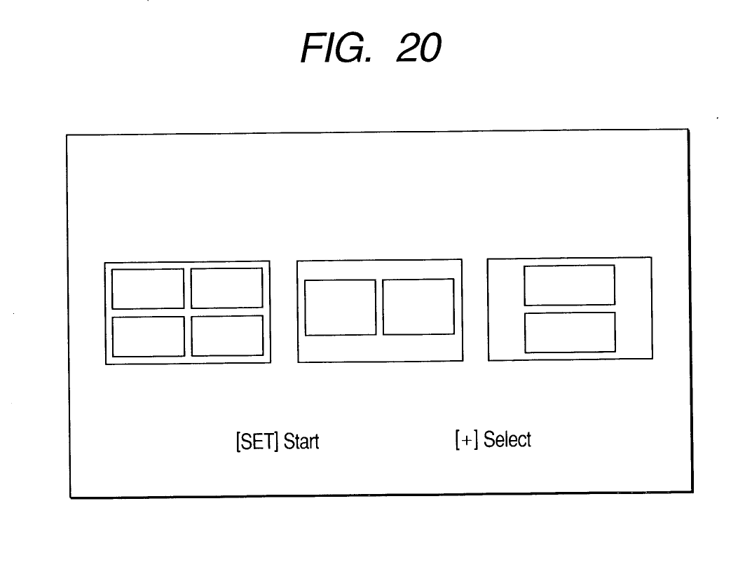

Each of the photographed images in the set is provided with information indicating the positional relationship, and the images can be combined to form a single panorama image in the image processing apparatus itself or after the images are transferred to a computer etc. FIG. 20 shows an example of the panorama mode selection image, in which shown are an icon, at the left-hand side, for selecting a 2×2 panorama mode for obtaining a two-dimensionally expanded panorama image, an icon at the center for selecting a horizontal panorama mode for obtaining a horizontal panorama image, and an icon at the right-hand side for selecting a vertical panorama mode for obtaining a vertical panorama image.

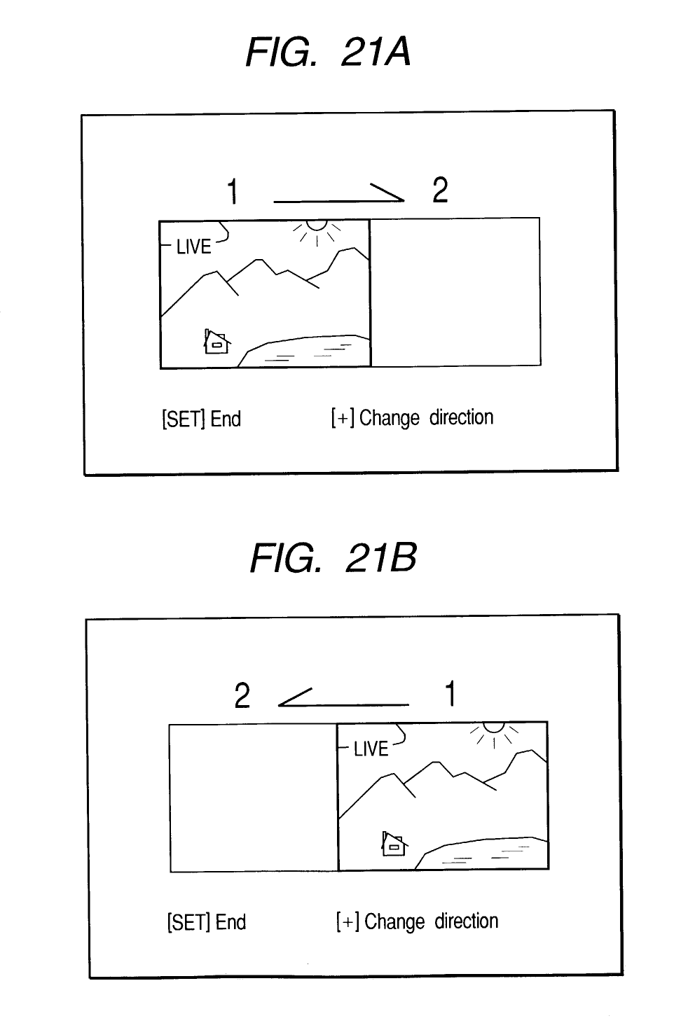

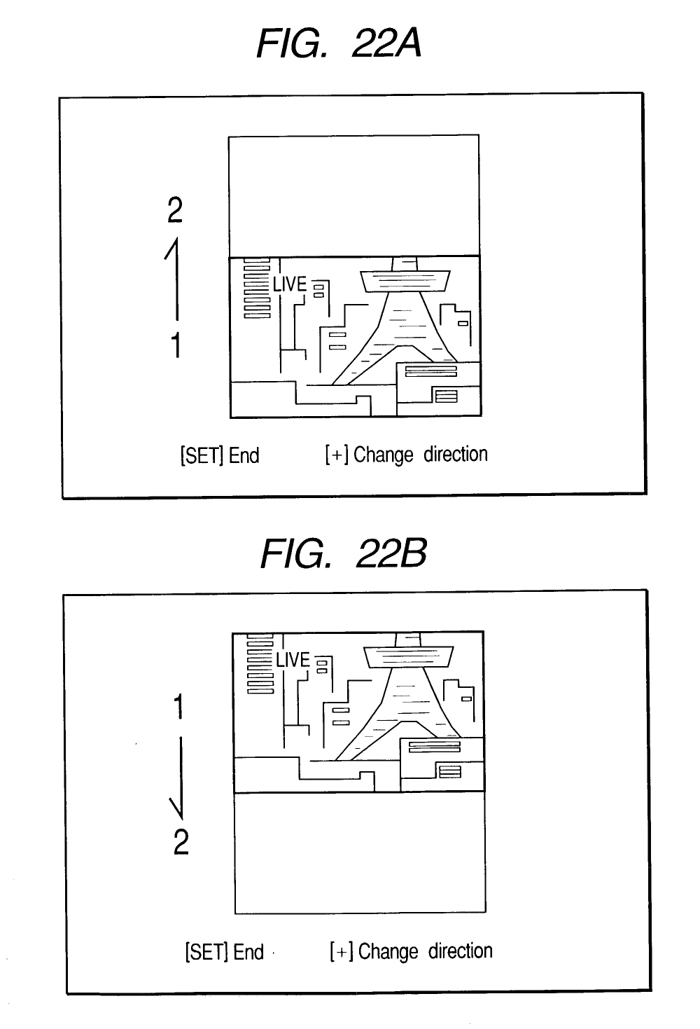

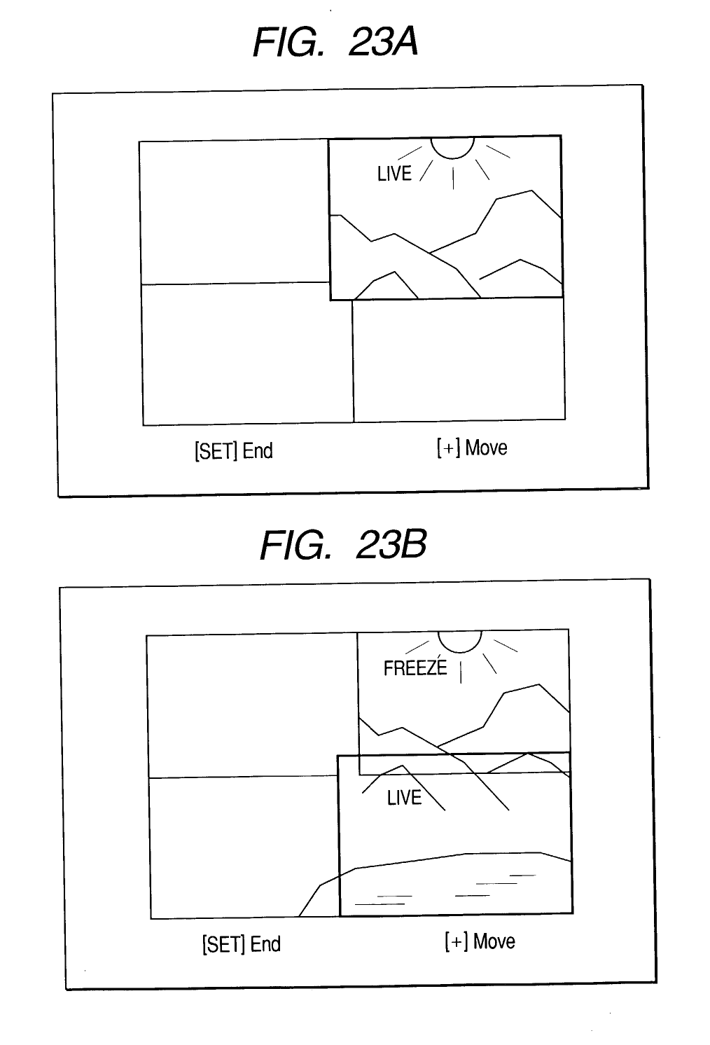

The user of the image pickup apparatus 100 can select a panorama mode for photographing by the selection/change switch 66 (for example [+] key) and determine such panorama mode by the determination/execution switch 68 (for example [SET] key). Upon selection of the panorama mode by the selection/change switch 66 and the determination/execution switch 68, the system control circuit 50 executes setting of initial values of flags, parameters and variables, setting of memory areas and readout of a display image as the user interface according to the selected panorama mode (S2502) and also in the 2×2 panorama mode initialization (S2503), the horizontal panorama mode initialization (S2504) or the vertical panorama mode initialization (S2505), then displays a panorama photographing image corresponding to each mode on the image display unit 28 (S2506), and proceeds to a step S2507. FIGS. 21A and 21B show an example of the horizontal panorama photographing image, FIGS. 22A and 22B show an example of the vertical panorama photographing image, and FIGS. 23A and 23B show an example of the 2×2 panorama photographing image.

Referring to FIGS. 21A and 21B, FIG. 21A shows an image for forming a panorama image by repeating the photographing operation to the right, and FIG. 21B shows an image for forming a panorama image by repeating the photographing operation to the left. A through image obtained by the electronic viewfinder is displayed in an area “1” as the first image in a set of panorama images, and the photographing to the right (FIG. 21A) and that to the left (FIG. 21B) can be switched any time by the selection/change switch 66 (for example [+] key) if the first image is not yet photographed. The direction of photographing can be determined by executing the photographing of the first image by depressing the shutter button while a desired state in FIG. 21A or 21B is displayed.

The photographing in the horizontal panorama mode can be terminated by depressing the determination/execution switch 68 (for example [SET] key). Referring to FIGS. 22A and 22B, FIG. 22A shows an image for forming a panorama image by repeating the photographing operation upward, and FIG. 22B shows an image for forming a panorama image by repeating the photographing operation downward.

A through image obtained by the electronic viewfinder is displayed in an area “1” as the first image in a set of panorama images, and the photographing upward (FIG. 22A) and that downward (FIG. 22B) can be switched any time by the selection/change switch 66 (for example [+] key) if the first image is not yet photographed. The direction of photographing can be determined by executing the photographing of the first image by depressing the shutter button while a desired state in FIG. 22A or 22B is displayed. The photographing in the vertical panorama mode can be terminated by depressing the determination/execution switch 68 (for example [SET] key).

Referring to FIGS. 23A and 23B, FIG. 23A shows an image for photographing a first frame in forming a 2×2 panorama image by repeating the photographing operation four times in two-dimensional manner, and FIG. 23B shows an image for a second frame. A through image obtained by the electronic viewfinder is displayed for example at the upper right area, for photographing the first image in a set of panorama images.

After the photographing of the first image, the photographed image is reproduced for example in the upper right area, and a through image obtained by the electronic viewfinder is displayed for example in the lower right area for the second photographing operation. The photographing area indicated by the electronic viewfinder is advanced in succession to a next area in each photographing operation, but the photographing operations can be started from an arbitrary area, and it is also possible to return to an already photographed area and to execute the photographing operation again. For this purpose, the photographing area can be shifted any time by the selection/change switch 66 (for example [+] key). The determination of the area for repeated photographing and the executing of the photographing therein are achieved by depressing the shutter button in a display state in which the desired area is selected. The photographing in the 2×2 panorama mode can be terminated by depressing the determination/execution switch 68 (for example [SET] key).

Again referring to FIGS. 18A and 18B, the system control circuit 50 initializes flags and variables set in the internal memory of the system control circuit 50 or in the memory 52. For example, it sets the panorama photographing start flag (S2507), then sets variables m, n and initializes these as m=1, n=1 (S2508) and proceeds to a step S2509. The resetting of the panorama photographing start flag indicates that none of the set of panorama images has been photographed. Also the variable m is used, in case of repeating the photographing operation in the horizontal or vertical panorama mode, for returning or not returning the photographing area to an immediately preceding position. The details of these flags and variables will be explained later.

If the mode dial 60 is set at a position other than the panorama mode, or if the termination of the panorama mode is selected by the depression of the determination/execution switch 68 (for example [SET] key) while the mode dial 60 remains set at the panorama mode, namely while the image display unit 28 displays any of the above-explained panorama photographing images (S2509), there is displayed an image form confirming the end of the panorama mode, and, if the end is confirmed, there is executed an end process for a set of panorama photographing operations (S2510), whereupon the panorama photographing process routine S2129 is terminated.

If the end of the panorama mode is not selected (S2509), the sequence proceeds to a step S2511. In case the selection/change switch 66 (for example [+] key) is depressed while the image display unit 28 displays one of the aforementioned panorama photographing images (S2511), the system control circuit 50 executes a predetermined process corresponding to the set panorama mode (S2512). If the selection/change switch 66 (for example [+] key) is not depressed, the sequence proceeds to a step S2520.

At first, in case of the 2×2 panorama mode, the system control circuit 50 executes a change of the variable n=n+1 thereby shifting the photographing area to a next area (S2513). If n=5 (S2514), a change n=n−4 is executed for returning to the initial photographing area (S2515), and the sequence then proceeds to a step S2520. Thus, in response to the depressions of the selection/change switch 66 (for example [+] key), the photographing area is shifted in succession in four areas of the 2×2 panorama mode, for example in the order of upper right, lower right, upper left, lower left, upper right, lower right, . . . .

On the other hand, in case of the horizontal or vertical panorama mode (S2512), if the panorama photographing start flag is reset, namely if prior to the first photographing operation in a set of panorama images (S2516), the system control circuit 50 inverts the photographing direction in each panorama mode (S2517), and then proceeds to a step S2520. Such inversion of the photographing direction can be repeated until the first photographing operation is executed.

FIGS. 21A and 21B show an example of the photographing direction inverting image in the horizontal panorama mode, wherein FIG. 21A shows a mode of repeating the photographing operation to the right, while FIG. 21B shows a mode of repeating the photographing operation to the left. Also FIGS. 22A and 22B show an example of the photographing direction inverting image in the vertical panorama mode, wherein FIG. 22A shows a mode of repeating the photographing operation upward, while FIG. 22B shows a mode of repeating the photographing operation downward.

Then, in case the horizontal or vertical panorama mode is selected (S2512) and the panorama photographing start flag is set, namely after the execution of the first photographing operation in a set of panorama images (S2516), the system control circuit 50 executes a calculation m=m*(−1) to obtain a successively inverted variable m=−1, +1, −1, +1, . . . (S2518) and then a calculation n=n+m to obtain a variable n=n−1, n=n+1, n=n−1, n=n+1, . . . (S2519), and thereafter proceeds to a step S2520.

These variables allow to repeatedly select a shift to the last photographed area in order to repeat the photographing operation, and a cancellation of the shift to the already photographed area.

More specifically, it is possible, after the photographing operation of an n-th image area in the panorama images, to depress the selection/change switch 66 (for example [+] key) for confirming the connection of the boundary area between the quick review image of an (n−1)th image area and that of an n-th image area, then to release the selection/change switch 66 (for example [+] key) thereby displaying a through image in the n-th image area, and to depress again the selection/change switch 66 (for example [+] key) thereby displaying the original quick review image of the n-th image area and a through image of an (n+1)th image area for executing the next photographing operation in the panorama images.

Also, after the photographing operation of an n-th image area in the panorama images, if the repetition of the photographing operation is decided at the confirmation of connection of the boundary area between the quick review image of an (n−1)th image area and that of an n-th image area by the depression of the selection/change switch 66 (for example [+] key), it is possible to release the selection/change switch 66 (for example [+] key) thereby displaying a through image in the n-th image area, and to depress the shutter switch SW2 in this display state to replace the displayed image with a newly photographed image, before proceeding to a next panorama photographing operation. The system control circuit 50 selects an n-th image area (S2520), and, if the image layout needs to be changed according to the selected image area (S2521), changes and displays the image layout (S2522), whereupon the sequence proceeds to a step S2531.

It is thus possible to display an image corresponding to the inversion of the photographing direction, an image corresponding to a change in the photographing area, or an image in which an explanatory text or an image is renewed, according to the necessity.

Also in the second and ensuing photographing operation, it is possible to display a reproduced image of the already photographed image and an image to be photographed next in a partly overlapping state, by setting the already photographed area in the quick review display state and also setting the shifted photographing area for the next photographing operation in the through display state. Consequently, the user of the image pickup apparatus 100 can easily determine the frame position of the next photographing operation.

Referring to FIG. 19, the system control circuit 50 sets the through display state in which the photographed image data are displayed in succession (S2531) and proceeds to a step S2532. In the through display state, an electronic finder function is realized by writing data in succession in the image display memory 24 through the image pickup device 12, A/D converter 16, image processing circuit 20, and memory control circuit 22, and displaying such data in succession in the aforementioned photographing area on the image display unit 28 through the memory control circuit 22 and the D/A converter 26.

Then, if the shutter switch SW1 is not depressed (S2532), the sequence returns to the step S2509. If the shutter switch SW1 is depressed (S2532), the sequence proceeds to a step S2533. The system control circuit 50 executes a range measuring process to focus the photographing lens 10 at an object, also a light measuring process to determine the diaphragm stop value and the shutter time and a white balancing process to match the color temperature (S2533). A flash setting is also executed if required in the light measuring process.

After the range measuring and light measuring processes, the sequence proceeds to a step S2534. Then, if the shutter switch SW2 is not depressed (S2534) and the shutter switch SW1 is released (S2535), the sequence returns to the step S2509. If the shutter switch SW2 is depressed (S2534), the sequence proceeds to a step S2536.

The system control circuit 50 executes a photographing process for obtaining an image by the image pickup device 12 (S2536).

Then the system control circuit 50 reads the photographed image data stored in the memory 30 by the photographing process S2540, then executes a vertical addition process and a color process if necessary, transferring the displayed image to the image display memory 24 through the memory control circuit 22 and sets the image display unit 28 at the quick review display state (S2537), whereupon the sequence proceeds to a step S2538.

In the quick review state, there is realized the electronic finder function of automatically reproducing the photographed image, by displaying the image data, transferred to the image display memory 24 by the display image process S2541, in the aforementioned photographing area on the image display unit 28 through the memory control circuit 22 and the D/A converter 26.

The system control circuit 50 reads the photographed image data stored in the memory 30, then executes various image processings and if necessary a pixel squaring process by the memory control circuit 22 and the image processing circuit 20 if necessary, then executes a compression process by the compression-expansion circuit 32 which executes an image compression according to the set mode (S2538), and executes a recording process of writing the image data into the recording medium 200 or 210 (S2539).

Also, if the image display unit 28 is turned on, a display such as “busy”, indicating that the writing operation is in progress, is provided thereon during the data writing into the recording medium 200 or 210. Also the display unit 54 is used for providing a display indicating the writing operation into the recording medium, for example by flashing of an LED.

Until the shutter switch SW2 is released (S2540), the system control circuit 50 continues the quick review display on the image display unit 28. Thus the user can confirm the photographed image cautiously during the depression of the shutter switch SW2. If the shutter switch SW2 is released (S2540), the system control circuit 50 sets the panorama photographing start flag (S2541), thereby indicating that the first photographing operation has been executed in the set of the panorama images.

In this manner, it is rendered possible to inhibit the inversion of the photographing direction, after the execution of the first photographing operation in the horizontal or vertical panorama mode, as already explained in the step S2516. The system control circuit 50 executes a change n=n+1 (S2542) for moving the next photographing area and an initialization m=1 (S2543), and then returns to the step S2509 for repeating the panorama photographing operation.

Therefore, the user can easily achieve connected image takings in the panorama photographing operations, by releasing the shutter switch SW2 for returning the sequence to the step S2509, then moving to the next photographing area in the step S2520, also setting the already photographed areas including the immediately preceding photographed area at the quick review display state and the next photographing area at the through display state in the step S2522, thereby displaying the already photographed images and the image to be photographed next in mutually overlapping manner.

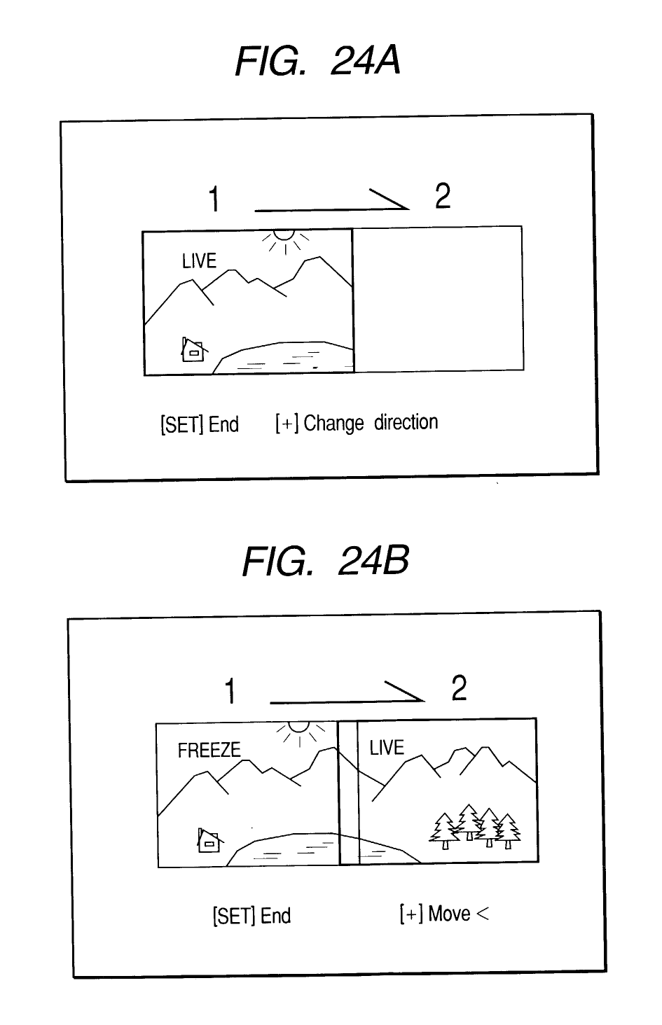

FIGS. 24A and 24B show an example of the photographing image before and after the n-th photographing operation in the horizontal panorama mode, wherein FIG. 24A shows the photographing image prior to the first photographing operation while FIG. 24B shows the photographing image in a state where the shutter switch SW2 is released after the first photographing operation. Until the shutter switch SW2 is released after the first photographing operation, the photographing image assumes a state shown in FIG. 24A, in which the first photographing area is replaced by the quick review display, though such state is not illustrated.

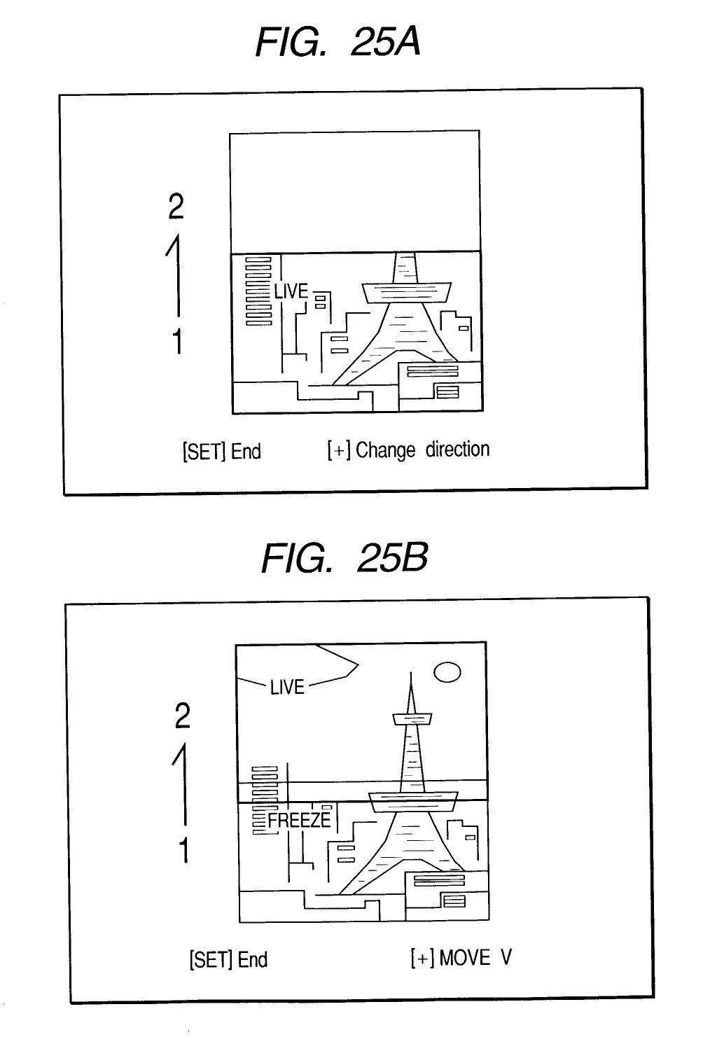

FIGS. 25A and 25B show an example of the photographing image before and after the n-th photographing operation in the vertical panorama mode, wherein FIG. 25A shows the photographing image prior to the first photographing operation while FIG. 25B shows the photographing image in a state where the shutter switch SW2 is released after the first photographing operation. Until the shutter switch SW2 is released after the first photographing operation, the photographing image assumes a state shown in FIG. 25A, in which the first photographing area is replaced by the quick review display, though such state is not illustrated.

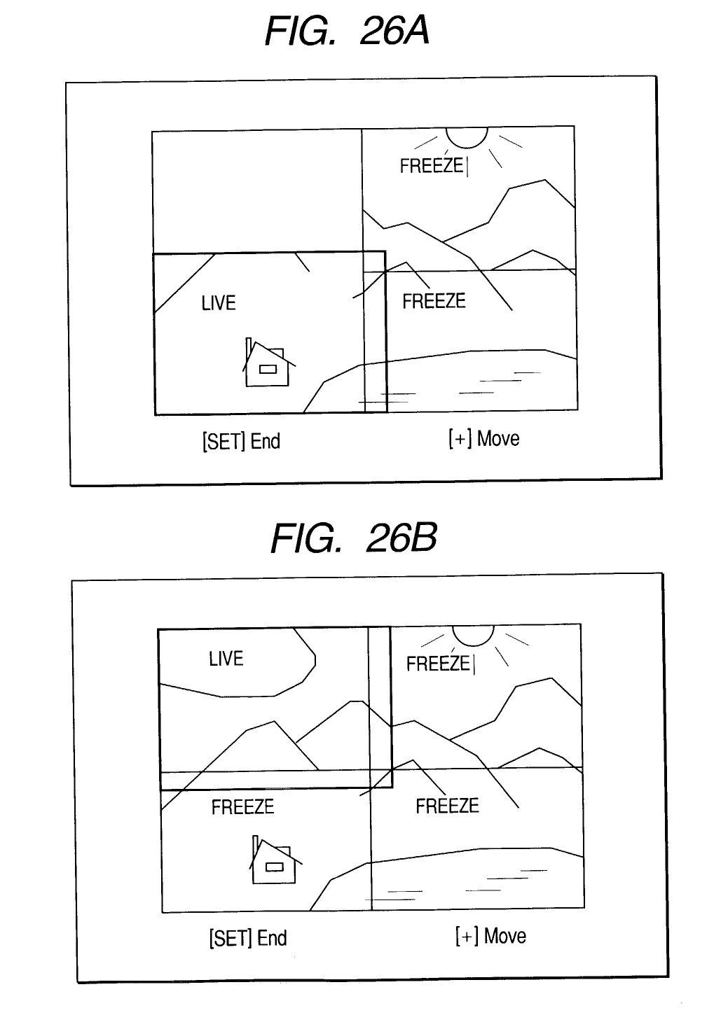

Also an example of the photographing image before and after the n-th photographing operation in the 2×2 panorama mode is shown in FIGS. 23A, 23B, 26A and 26B, wherein FIG. 23A shows the photographing image prior to the first photographing operation, FIG. 23B shows the photographing image in a state where the shutter switch SW2 is released after the first photographing operation, FIG. 26A shows the photographing image in a state where the shutter switch SW2 is released after the second photographing operation, namely before the third photographing operation, and FIG. 26B shows a state in which the shutter switch SW2 is released after the third photographing operation, namely before the fourth photographing operation.

Until the shutter switch SW2 is released after the n-th photographing operation, the photographing image assumes a state shown in FIG. 23A, 23B, 26A or 26B in which the n-th photographing area is replaced by the quick review display, though such state is not illustrated. When the shutter switch SW2 is released, there is added the through display of the next (n+1)th photographing area.

In the third embodiment of the present invention, as explained in the foregoing, in the ordinary photographing mode, the information relating to the photographed image is transmitted to the image gateway 400 for each photographing operation in the image pickup apparatus 100 both in the single and continuous photographing operation, whereby the image can be registered in the image gateway 400 in linkage with the photographing operation in the image pickup apparatus 100. It is thus made possible to register the photographed image any time without awaiting the completion of a series of continuous photographing operations, and to realize the image transmitting operation synchronized with the photographing operation.

On the other hand, in the panorama photographing mode, after the serial panorama photographing operations in the image pickup apparatus 100, the information on thus photographed serial panorama images is collectively transmitted together with the images to the image gateway 400, whereby the image data of related plural images and the information relating to such image data can be securely transmitted. It is thus possible to collectively manage the image data of the serially photographed panorama images and to securely deliver such image data to the client computer 500 through the image gateway 400.

According to the third embodiment, as will be apparent from the foregoing description, the mutually related plural images obtained by the serial photographing operations are collectively transmitted and registered from the image pickup apparatus 100 to the image gateway 400, whereby the image gateway 400 can collectively manage the serially photographed and thus registered image data.

[Other Embodiments]

The objects of the present invention can naturally be attained also by supplying a system or an apparatus with a memory medium storing program codes of a software realizing the functions of the aforementioned embodiments, and causing a computer (or CPU or MPU) of such system or apparatus to read and execute the program codes stored in the memory medium.

In such case, the program codes themselves read from the memory medium realize the functions of the aforementioned embodiments, and the memory medium storing the program codes constitutes the present invention. The memory medium for supplying the program codes can be, for example, a flexible disk, a hard disk, an optical disk, a magnetooptical disk, a CD-ROM, a CD-R, a magnetic tape, a non-volatile memory card or a ROM.

The present invention naturally includes not only a case where the functions of the aforementioned embodiments are realized by execution of the read program codes by a computer but also a case where an OS (operating system) or the like functioning on a computer executes all the actual processes or a part thereof under the instructions of such program codes, thereby realizing the functions of the aforementioned embodiments.

The present invention further includes a case where the program codes read from the memory medium are once stored in a function expansion board inserted into the computer or a function expansion unit connected thereto and a CPU or the like provided in such function expansion board or function expansion unit executes all the actual processes or a part thereof under the instructions of such program codes, thereby realizing the functions of the aforementioned embodiments.

What is claimed is:

1. An image pickup apparatus comprising:
storage unit for storing an input image;
transmission means for transmitting information relating to said image, stored in said storage means, to an external apparatus;
operation means for executing an operation for opening said information, transmitted to said external apparatus, to another apparatus; and
control means for controlling at least either of a transmitting operation by said transmission means and the operation by said operation means, according to an operation mode of said image pickup apparatus.

2. An apparatus according to claim 1, wherein the information relating to said image is information including at least one of image data, a thumbnail and a file name of said image.

3. An apparatus according to claim 1, wherein said control means automatically permits or inhibits at least one of the transmitting operation by said transmission means and the operation by said operation means, according to said operation mode.

4. An apparatus according to claim 1, further comprising:
photographing means for photographing said image, wherein said control means controls at least one of the transmitting operation by said transmission means and the operation by said operation means, according to a mode of a user interface for operating said photographing means.

5. An apparatus according to claim 4, further comprising:
input means for entering identification information relating to the user, wherein said control means judges the mode of the user interface according to said entered identification information.

6. An apparatus according to claim 1, wherein said operation mode is a mode relating to the reproduction of said image, and said control means controls at least either of a transmitting operation by said transmission means and the operation by said operation means, according to the operation in the course of execution of said reproduction mode.

7. An apparatus according to claim 6, further comprising:
photographing means for photographing said image and display means for displaying the photographed image, wherein said reproduction mode is a preview mode for displaying, for confirmation, the image immediately after photographing by said photographing means.

8. An apparatus according to claim 1, further comprising:
photographing means for photographing said image, wherein said control means controls at least either of the transmitting operation by said transmission means and the operation by said operation means, according to the photographing mode in said photographing means.

9. An apparatus according to claim 8, wherein said photographing mode includes at least an ordinary photographing mode and a panorama photographing mode, and said control means controls at least either of the transmitting operation by said transmission means and the operation by said operation means, according to said set photographing mode.

10. An image management system composed of an image storage apparatus, and an image management apparatus connected to a network and adapted to manage the image stored in said image storage apparatus, the system comprising:
said image storage apparatus which includes transmission means for transmitting information relating to the image to said image management apparatus;
said image management apparatus being adapted to open said information on the network;
operation means provided in said image storage apparatus and adapted to execute an operation relating to the setting for opening said information; and
control means for controlling said transmission means and said operation means and permitting or inhibiting the opening of said information according to the operation mode of said image storage apparatus.
